(19) United States
(12) Patent Application Publication
(10) Pub. No.: US 2024/0289798 A1
(43) Pub. Date: Aug. 29, 2024

(54) TECHNIQUES TO PROVIDE SECURE CRYPTOGRAPHIC AUTHENTICATION, VERIFICATION, FUNCTIONALITY ACCESS, AND PAYMENTS BETWEEN CONTACTLESS CARDS AND COMMUNICATION DEVICES

(71) Applicant: Capital One Services, LLC, McLean, VA (US)

(72) Inventors: Bob Uni Koshy, Herico, VA (US); Kevin Osborn, Newton Highlands, MA (US); Paul Young Moreton, Tuscaloosa, AL (US); Wayne Lutz, Fort Washington, MD (US); Casey Barrett, San Francisco, CA (US); Jonathan T. Blocksom, Reston, VA (US)

(73) Assignee: Capital One Services, LLC, McLean, VA (US)

(21) Appl. No.: 18/407,995

(22) Filed: Jan. 9, 2024

Related U.S. Application Data
(63) Continuation-in-part of application No. 18/207,831, filed on Jun. 9, 2023.
(60) Provisional application No. 63/437,979, filed on Jan. 9, 2023.

(51) Int. Cl. G06Q 20/40; G06Q 20/34; G06Q 20/38

(52) U.S. Cl. CPC G06Q 20/40145; G06Q 20/352; G06Q 20/3829

(57) ABSTRACT

Systems and methods to provide secure cryptographic authentication, verification, functionality access, and payments between contactless cards and communication devices are provided. An exemplary communication device includes a system on a chip and generates a communication field, displays a prompt to tap a contactless card on the communication device, reads the contactless card after entry into the communication field, performs an authentication of the contactless card, and after a successful authentication of the contactless card, and performs a payment transaction.

### CROSS-REFERENCE TO RELATED APPLICATIONS

This application is a continuation-in-part of U.S. patent application Ser. No. 18/207,831, entitled “Techniques To Process Contactless Card Functions In A Multiple Banking Systems Environment” and filed Jun. 9, 2023, and claims priority to U.S. Provisional Patent Application No. 63/437,979, entitled “Techniques To Provide Secure Cryptographic Authentication, Verification, Functionality Access, And Payments Between Contactless Cards And Communication Devices” and filed Jan. 9, 2023, the disclosures of which are incorporated by reference herein in their entireties.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity. Accordingly, there is a need to provide businesses and users with an appropriate solution that overcome current deficiencies to provide data security, authentication, verification, access to functionalities, and payments for contactless cards.

In one aspect, a communication device includes a system on a chip (SoC), where the communication device generates a communication field, displays a prompt to tap a contactless card on the communication device, reads the contactless card after entry into the communication field, performs an authentication of the contactless card, and after a successful authentication of the contactless card, performs a payment transaction.

In one aspect, a method performed by a communication device including a system on a chip includes generating a communication field, displaying a prompt to tap a contactless card on the communication device, reading the contactless card after entry into the communication field, performing an authentication of the contactless card, and after a successful authentication of the contactless card, performing a payment transaction.

In one aspect, a non-transitory computer-readable medium includes instructions for execution by a communication device, where, upon execution of the instructions the communication device performs procedures includes generating a communication field, displaying a prompt to tap a contactless card on the communication device, reading the contactless card after entry into the communication field, performing an authentication of the contactless card, and after a successful authentication of the contactless card, performing a payment transaction.

### BRIEF DESCRIPTION OF THE SEVERAL VIEWS OF THE DRAWINGS

Various embodiments of the present disclosure, together with further objects and advantages, may best be understood by reference to the following description taken in conjunction with the accompanying drawings.

FIG. 1 illustrates a data transmission system in accordance with an example embodiment.

FIG. 2 illustrates a data transmission system in accordance with an example embodiment.

FIG. 3 illustrates a contactless card in accordance with an example embodiment.

FIG. 4 illustrates a contactless card component in accordance with an example embodiment.

FIG. 5 illustrates a sequence flow in accordance with an example embodiment.

FIG. 6 illustrates a data structure n accordance with an example embodiment.

FIG. 7 is a diagram of a key system in accordance with an example embodiment.

FIG. 8 is a flowchart of a method of generating a cryptogram in accordance with an example embodiment.

FIG. 9 illustrates a process for key diversification in accordance with an example embodiment.

FIG. 10 illustrates a method for card activation in accordance with an example embodiment.

FIG. 11 illustrates a method of for cryptographic authentication and functionality access for a contactless card in accordance with an example embodiment.

FIG. 12 illustrates a method of for cryptographic authentication and functionality access for a contactless card in accordance with an example embodiment.

FIG. 13 illustrates a multi-issuer system in accordance with an example embodiment.

FIG. 14 illustrates a system in accordance with an example embodiment.

FIG. 15 illustrates a system in accordance with an example embodiment.

FIG. 16 illustrates a sequence flow in accordance with an example embodiment.

FIG. 17A illustrates a sequence flow in accordance with an example embodiment.

FIG. 17B illustrates a sequence flow in accordance with an example embodiment.

FIG. 17C illustrates a sequence flow in accordance with an example embodiment.

FIG. 18 illustrates a flowchart of a method of key identification in accordance with an example embodiment.

FIG. 19 illustrates a flowchart of a method of key generation in accordance with an example embodiment.

FIG. 20 illustrates a flowchart of generating a cryptogram in accordance with an example embodiment.

FIG. 21 illustrates a flowchart of a method of enciphering a cryptogram in accordance with an example embodiment.

FIG. 22 illustrates a flowchart of a method of calculating a message authentication code in accordance with an example embodiment.

FIG. 23 illustrates a message in accordance with an example embodiment.

FIG. 24 illustrates a flowchart of a method of establishing a session and performing a function in accordance with an example embodiment.

FIG. 25 illustrates a distributed network authentication system in accordance with an example embodiment.

FIG. 26 illustrates a flow chart of a method performed by a distributed network authentication system in accordance with an example embodiment.

FIG. 27 illustrates a computer architecture in accordance with an example embodiment.

FIG. 28 illustrates a communications architecture in accordance with an example embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Embodiments may be generally directed enabling contactless card functions in a multi-issuer computing environment. These functions may include tap-to functions where a user may tap their contactless card on a device, such as a mobile device, to perform a function. For example, a user may utilize their contactless card to verify their identify, perform a payment, launch applications, login into applications, autofill a form or field, navigate to a specified web location or app on a device, unlock a door, initiate a contactless card, and so forth.

The systems discussed here may enable users to perform these functions in a multi-issuer environment. Further, the systems discussed herein enable card issuers, such as a banks, to issue contactless cards with tap-to functions to customers while maintaining a high-level security. The systems discussed differ from previous solutions because they provide a single platform for multiple issuers or banks to provide the tap to functionality. Traditionally, each issuer or bank would be required to set up and maintain their own systems to provide the contactless card features. This includes maintaining their own hardware, software, databases, security protocols, and so forth, which can become extremely costly for the issuer or banks to maintain. However, embodiments discussed enable issuers or banks to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that another issuer or bank cannot access another issuer's data or functions. As will be discussed in more detail, these features may be provided by a switchboard system that is configured to process and perform each contactless card function in a secure manner. Additional benefits for issuers may include providing a highly secure authentication option for mobile web, which typically lack the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

Embodiments discussed herein disclose systems and methods for implementing secure authentication, communication, verification, and payments between contactless cards and communication devices configured to communicate with contactless cards. Communication devices may include, without limitation, client devices, point-of-sale (POS) terminals, kiosks, cash registers, automated teller machines (ATMs), point of access devices, network-enabled computers, and mobile devices (e.g., a smartphone). The communication devices can, potentially in connection with a server or other communication devices, perform authentication of contactless cards, communication with contactless cards, verification of a user and/or information with contactless cards, payment transactions with contactless cards, and access to functionalities by contactless cards.

In embodiments, the systems and methods discussed herein provide for the authentication of contactless cards using communication devices. Communication devices may generate a communication field for communication with a contactless card, e.g., a near field communication (NFC) field, and may be configured to prompt a user to tap, swipe, or wave the contactless card in the vicinity of the communication device. After receiving a tap, swipe, or wave gesture of the contactless card into the communication field, secure communication between the contactless card and the communication device can begin. Data exchanged between the contactless card and the communication device can be used to authenticate the contactless card and enable further functions and processes as discussed herein.

Authentication of the contactless card may be performed by, for example, the systems and methods discussed herein. Once authenticated, the communication device can provide access to one or more additional functionalities. This may include the presentation of one or more additional user interfaces and access to additional functionalities. In some examples, additional user interfaces can process a payment transaction. In some examples, additional user interfaces can seek additional verification from the user. In some examples, additional user interfaces can provide access to additional functionalities.

In embodiments, the communication device can operate using a combination of components for a computer system (e.g., processors, memories for primary storage and second storage, input/output devices, and input/output interfaces) to perform the functions and processes discussed herein. In other examples, communication devices can operate using one or more systems on a chip (SoCs) comprising an integrated circuit having one or more of the above-noted components to perform the functions and processes discussed herein.

The systems and methods discussed herein provide a number of benefits. For example, the use of communication devices, e.g., communication devices utilizing one or more SoCs, allows for the functions and processes discussed herein to be implemented across a broad range of devices. This can be accomplished while advantageously minimizing the need for hardware and software integration into the communication devices.

As another example, to perform the functions and processes discussed herein, the contactless card issuing entity is only required to provide information, including information used for authentication, when needed. This can reduce fees charged by the card issuing entity or other entities providing data.

As another example, the functions and processes discussed herein can be performed on the communication device alone or on the communication device in connection with one or more servers or other communication devices. The one or more servers or other communication entities can be provided and/or operated by the card-issuing entity and/or other entities involved in the provision of goods or services or the processing of transactions. Performance by the communication device of some or all of the functions and processes discussed herein can simplify these functions and processes by reducing the number entities required to be involved. In addition, performance by the communication device of some or all of the functions and processes discussed herein can better align the functions and processes needing to be performed following a single tap, swipe, or wave of the contactless card on the communication device.

As another example, the systems and methods discussed herein promote the verification of a user to allow for the provision of additional functionalities, such as entertainment content, sports content, other media content, discounts, promotions, loyalty benefits, rewards points, and/or other additional functionalities through the user's interaction with the communication device. In some examples, these provisions can be made prior to performing a payment transaction, and accordingly, the payment transaction (e.g., the payment amount) can accurately reflect these provisions.

All of the foregoing examples provide many advantages with respect to data security, authentication, verification, functionality access, and payments for contactless cards. It is understood that these and further advantages may be achieved by a combination of one or more of the foregoing examples. It is further understood that elements, features, and functionalities of the examples discussed herein are interchangeable and interchangeably combinable.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations discussed herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

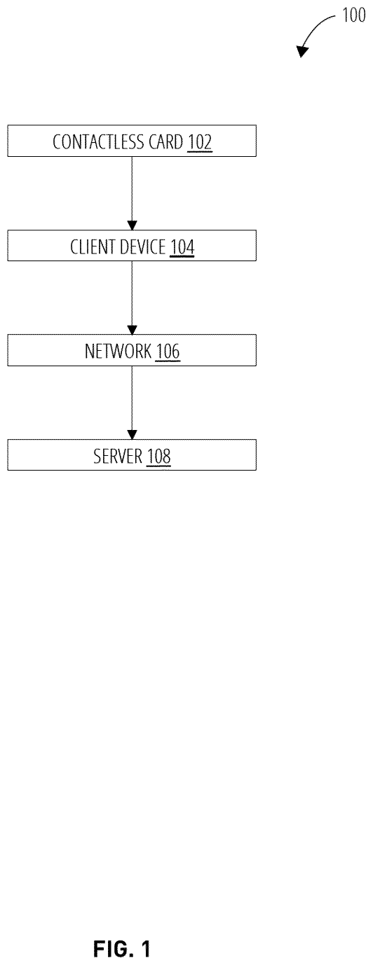

FIG. 1 illustrates a data transmission system 100 according to an example embodiment. As further discussed below, system 100 may include contactless card 102, client device 104, network 106, and server 108. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with client device 104.

System 100 may include client device 104, which may be a network-enabled computer. As referred to herein, a network-enabled computer may include, but is not limited to, a computer device or a communication device including, e.g., a server, a network appliance, a personal computer (PC), a workstation, a phone, a handheld PC, a personal digital assistant, a thin client, a fat client, an Internet browser, a contactless card, a point-of-sale (POS) terminal, a kiosk, a cash register, an automated teller machine (ATM), a point of access device, or other device. Client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 104 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions discussed herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices discussed herein.

In some examples, client device 104 of system 100 may execute one or more applications, such as software applications, that enable, for example, network communications with one or more components of system 100 and transmit and/or receive data.

The client device 104 may be in communication with one or more server(s) 108 via one or more network(s) 106, and may operate as a respective front-end to back-end pair with server 108. The client device 104 may transmit, for example from a mobile device application executing on client device 104, one or more requests to server 108. The one or more requests may be associated with retrieving data from server 108. The server 108 may receive the one or more requests from client device 104. Based on the one or more requests from client device 104, server 108 may be configured to retrieve the requested data from one or more databases (not shown). Based on receipt of the requested data from the one or more databases, server 108 may be configured to transmit the received data to client device 104, the received data being responsive to one or more requests.

System 100 may include one or more networks 106. In some examples, network 106 may be one or more of a wireless network, a wired network or any combination of wireless network and wired network, and may be configured to connect client device 104 to server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof, network 106 may further include one network, or any number of the exemplary types of networks mentioned above, operating as a stand-alone network or in cooperation with each other, network 106 may utilize one or more protocols of one or more network elements to which they are communicatively coupled, network 106 may translate to or from other protocols to one or more protocols of network devices. Although network 106 is depicted as a single network, it should be appreciated that according to one or more examples, net work 106 may comprise a plurality of interconnected networks, such as, for example, the Internet, a service provider's network, a cable television network, corporate networks, such as credit card association networks, and home networks.

System 100 may include one or more servers 108. In some examples, server 108 may include one or more processors, which are coupled to memory. The server 108 may be configured as a central system, server or platform to control and call various data at different times to execute a plurality of workflow actions. Server 108 may be configured to connect to the one or more databases. The server 108 may be connected to at least one client device 104. Server 108 can be a dedicated server computer, a bladed server, or can be a personal computer, a laptop computer, a notebook computer, a palm top computer, a network computer, a mobile device, a wearable device, or any processor-controlled device capable of supporting the system 100, including a network-enabled computer.

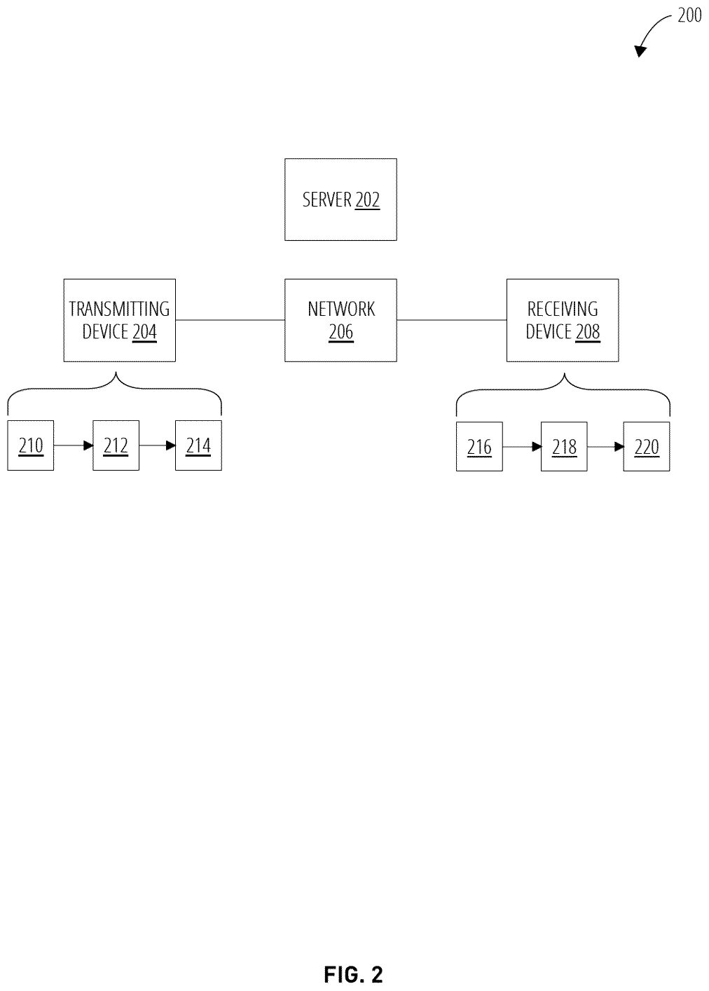

FIG. 2 illustrates a data transmission system according to an example embodiment. System 200 may include a transmitting or transmitting device 204, a receiving or receiving device 208 in communication, for example via network 206, with one or more servers 202. Transmitting device 204 may be the same as, or similar to, client device 104 discussed above with reference to FIG. 1. Receiving device 208 may be the same as, or similar to, client device 104 discussed above with reference to FIG. 1. Network 206 may be similar to network 115 discussed above with reference to FIG. 1. Server 202 may be the same as, or similar to, server 120 discussed above with reference to FIG. 1. Although FIG. 2 shows single instances of components of system 200, system 200 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further discussed herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 2, system 200 may be configured to implement key diversification. For example, a sender and recipient may desire to exchange data (e.g., original sensitive data) via respective devices 204 and 208. As explained above, although single instances of transmitting device 204 and receiving device 208 may be included, it is understood that one or more transmitting devices 204 and one or more receiving devices 208 may be involved so long as each party shares the same shared secret symmetric key. In some examples, the transmitting device 204 and receiving device 208 may be provisioned with the same master symmetric key. Further, it is understood that any party or device holding the same secret symmetric key may perform the functions of the transmitting device 204 and similarly any party holding the same secret symmetric key may perform the functions of the receiving device 208. In some examples, the symmetric key may comprise the shared secret symmetric key which is kept secret from all parties other than the transmitting device 204 and the receiving device 208 involved in exchanging the secure data. It is further understood that both the transmitting device 204 and receiving device 208 may be provided with the same master symmetric key, and further that part of the data exchanged between the transmitting device 204 and receiving device 208 comprises at least a portion of data which may be referred to as the counter value. The counter value may comprise a number that changes each time data is exchanged between the transmitting device 204 and the receiving device 208.

System 200 may include one or more networks 206. In some examples, network 206 may be one or more of a wireless network, a wired network or any combination of wireless network and wired network, and may be configured to connect one or more transmitting devices 204 and one or more receiving devices 208 to server 202. For example, network 206 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 206 may include, without limitation, telephone lines, fiber optics, IEEE Ethernet 902.3, a wide area network, a wireless personal area network, a LAN, or a global network such as the Internet. In addition, network 206 may support an Internet network, a wireless communication network, a cellular network, or the like, or any combination thereof. Network 206 may further include one network, or any number of the exemplary types of networks mentioned above, operating as a stand-alone network or in cooperation with each other. Network 206 may utilize one or more protocols of one or more network elements to which they are communicatively coupled. Network 206 may translate to or from other protocols to one or more protocols of network devices. Although network 206 is depicted as a single network, it should be appreciated that according to one or more examples, network 206 may comprise a plurality of interconnected networks, such as, for example, the Internet, a service provider's network, a cable television network, corporate networks, such as credit card association networks, and home networks.

In some examples, one or more transmitting devices 204 and one or more receiving devices 208 may be configured to communicate and transmit and receive data between each other without passing through network 206. For example, communication between the one or more transmitting devices 204 and the one or more receiving devices 208 may occur via at least one of NFC, Bluetooth, RFID, Wi-Fi, and/or the like.

At block 210, when the transmitting device 204 is preparing to process the sensitive data with symmetric cryptographic operation, the sender may update a counter. In addition, the transmitting device 204 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 212, the transmitting device 204 may take the selected cryptographic algorithm, and using the master symmetric key, process the counter value. For example, the sender may select a symmetric encryption algorithm, and use a counter which updates with every conversation between the transmitting device 204 and the receiving device 208. The transmitting device 204 may then encrypt the counter value with the selected symmetric encryption algorithm using the master symmetric key, creating a diversified symmetric key.

In some examples, the counter value may not be encrypted. In these examples, the counter value may be transmitted between the transmitting device 204 and the receiving device 208 at block 212 without encryption.

At block 214, the diversified symmetric key may be used to process the sensitive data before transmitting the result to the receiving device 208. For example, the transmitting device 204 may encrypt the sensitive data using a symmetric encryption algorithm using the diversified symmetric key, with the output comprising the protected encrypted data. The transmitting device 204 may then transmit the protected encrypted data, along with the counter value, to the receiving device 208 for processing.

At block 216, the receiving device 208 may first take the counter value and then perform the same symmetric encryption using the counter value as input to the encryption, and the master symmetric key as the key for the encryption. The output of the encryption may be the same diversified symmetric key value that was created by the sender.

At block 218, the receiving device 208 may then take the protected encrypted data and using a symmetric decryption algorithm along with the diversified symmetric key, decrypt the protected encrypted data.

At block 220, as a result of the decrypting the protected encrypted data, the original sensitive data may be revealed.

The next time sensitive data needs to be sent from the sender to the recipient via respective transmitting device 204 and receiving device 208, a different counter value may be selected producing a different diversified symmetric key. By processing the counter value with the master symmetric key and same symmetric cryptographic algorithm, both the transmitting device 204 and receiving device 208 may independently produce the same diversified symmetric key. This diversified symmetric key, not the master symmetric key, is used to protect the sensitive data.

As explained above, both the transmitting device 204 and receiving device 208 each initially possess the shared master symmetric key. The shared master symmetric key is not used to encrypt the original sensitive data. Because the diversified symmetric key is independently created by both the transmitting device 204 and receiving device 208, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 204 and the receiving device 208 may be governed by symmetric requirements for how often to create a new diversification value, and therefore a new diversified symmetric key. In an embodiment, a new diversification value and therefore a new diversified symmetric key may be created for every exchange between the transmitting device 204 and receiving device 208.

In some examples, the key diversification value may comprise the counter value. Other non-limiting examples of the key diversification value include: a random nonce generated each time a new diversified key is needed, the random nonce sent from the transmitting device 204 to the receiving device 208; the full value of a counter value sent from the transmitting device 204 and the receiving device 208; a portion of a counter value sent from the transmitting device 204 and the receiving device 208; a counter independently maintained by the transmitting device 204 and the receiving device 208 but not sent between the two devices; a one-time-passcode exchanged between the transmitting device 204 and the receiving device 208; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes discussed herein. A new diversification value, and therefore a new diversified symmetric key, may be created as often as needed. In the most secure case, a new diversification value may be created for each exchange of sensitive data between the transmitting device 204 and the receiving device 208. In effect, this may create a one-time use key, such as a single-use session key.

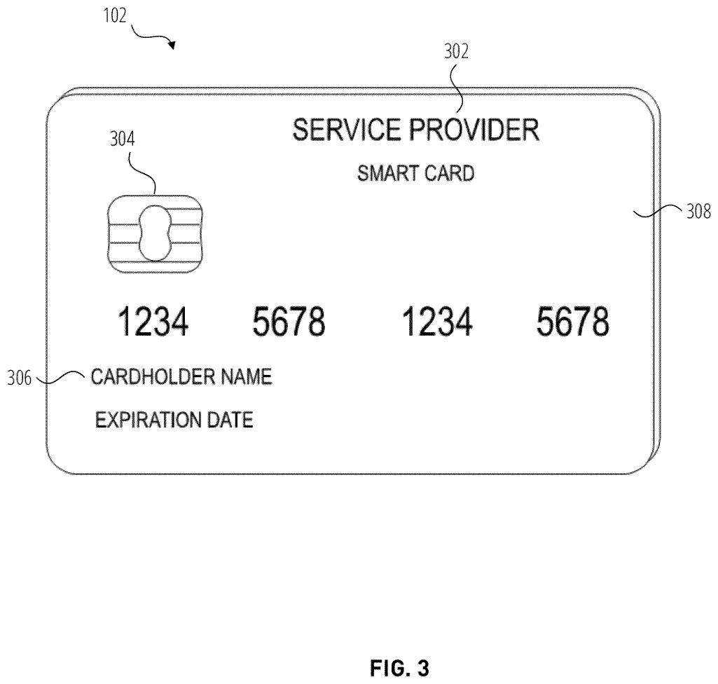

FIG. 3 illustrates an example configuration of a contactless card 102, which may include a contactless card, a payment card, such as a credit card, debit card, or gift card, issued by a service provider as displayed as service provider indicia 302 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

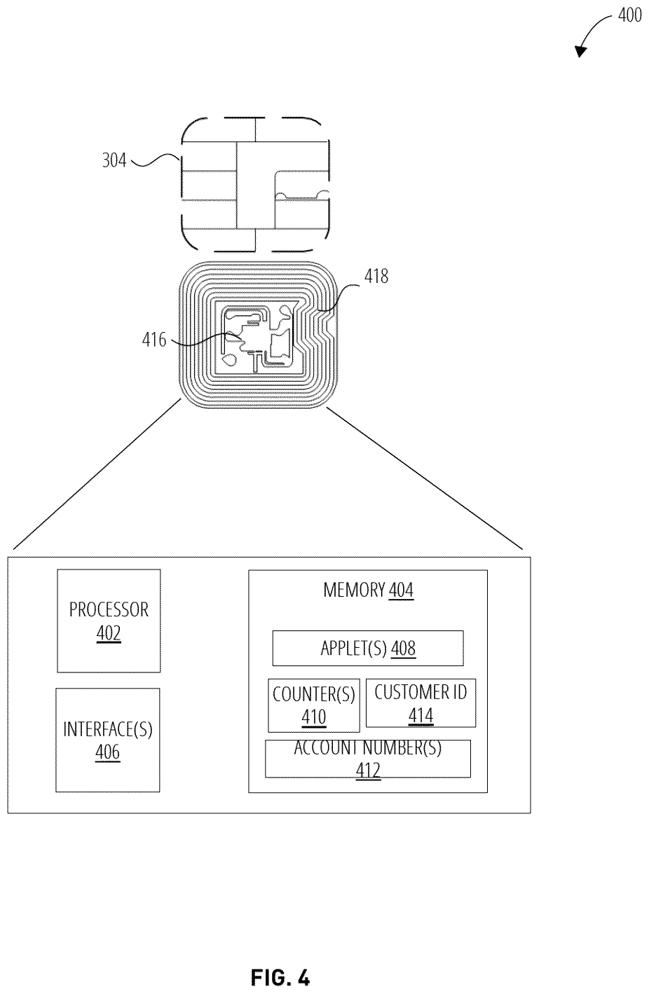

The contactless card 102 may also include identification information 306 displayed on the front and/or back of the card, and a contact pad 304. The contact pad 304 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 4. These components may be located behind the contact pad 304 or elsewhere on the substrate 308, e.g. within a different layer of the substrate 308, and may electrically and physically coupled with the contact pad 304. The contactless card 102 may also include a magnetic strip or tape, which may be located on the back of the card (not shown in FIG. 3). The contactless card 102 may also include a Near-Field Communication (NFC) device coupled with an antenna capable of communicating via the NFC protocol. Embodiments are not limited in this manner.

As illustrated in FIG. 2, the contact pad 304 of contactless card 102 may include processing circuitry 416 for storing, processing, and communicating information, including a processor 402, a memory 404, and one or more interface(s) 406. It is understood that the processing circuitry 416 may contain additional components, including processors, memories, error and parity/CRC checkers, data encoders, anticollision algorithms, controllers, command decoders, security primitives and tamperproofing hardware, as necessary to perform the functions discussed herein.

The memory 404 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 404 may be encrypted memory utilizing an encryption algorithm executed by the processor 402 to encrypted data.

The memory 404 may be configured to store one or more applet(s) 408, one or more counter(s) 410, a customer identifier 414, and the account number(s) 412, which may be virtual account numbers. The one or more applet(s) 408 may comprise one or more software applications configured to execute on one or more contactless cards, such as a Java® Card applet. However, it is understood that applet(s) 408 are not limited to Java Card applets, and instead may be any software application operable on contactless cards or other devices having limited memory. The one or more counter(s) 410 may comprise a numeric counter sufficient to store an integer. The customer identifier 414 may comprise a unique alphanumeric identifier assigned to a user of the contactless card 102, and the identifier may distinguish the user of the contactless card from other contactless card users. In some examples, the customer identifier 414 may identify both a customer and an account assigned to that customer and may further identify the contactless card 102 associated with the customer's account. As stated, the account number(s) 412 may include thousands of one-time use virtual account numbers associated with the contactless card 102. An applet(s) 408 of the contactless card 102 may be configured to manage the account number(s) 412 (e.g., to select an account number(s) 412, mark the selected account number(s) 412 as used, and transmit the account number(s) 412 to a mobile device for autofilling by an autofilling service.

The processor 402 and memory elements of the foregoing exemplary embodiments are described with reference to the contact pad 304, but the present disclosure is not limited thereto. It is understood that these elements may be implemented outside of the contact pad 304 or entirely separate from it, or as further elements in addition to processor 402 and memory 404 elements located within the contact pad 304.

In some examples, the contactless card 102 may comprise one or more antenna(s) 418. The one or more antenna(s) 418 may be placed within the contactless card 102 and around the processing circuitry 416 of the contact pad 304. For example, the one or more antenna(s) 418 may be integral with the processing circuitry 416 and the one or more antenna(s) 418 may be used with an external booster coil. As another example, the one or more antenna(s) 418 may be external to the contact pad 304 and the processing circuitry 416.

In an embodiment, the coil of contactless card 102 may act as the secondary of an air core transformer. The terminal may communicate with the contactless card 102 by cutting power or amplitude modulation. The contactless card 101 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 418, processor 402, and/or the memory 404, the contactless card 101 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 408 may be added to contactless cards to provide a one-time password (OTP) for multifactor authentication (MFA) in various mobile application-based use cases. Applet(s) 408 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 408 may be configured to encode the OTP as an NDEF type 4 well known type text tag. In some examples, NDEF messages may comprise one or more records. The applet(s) 408 may be configured to add one or more static tag records in addition to the OTP record.

In some examples, the one or more applet(s) 408 may be configured to emulate an RFID tag. The RFID tag may include one or more polymorphic tags. In some examples, each time the tag is read, different cryptographic data is presented that may indicate the authenticity of the contactless card. Based on the one or more applet(s) 408, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 410 may be configured to increment. In some examples, each time data from the contactless card 102 is read (e.g., by a mobile device), the counter(s) 410 is transmitted to the server for validation and determines whether the counter(s) 410 are equal (as part of the validation) to a counter of the server.

The one or more counter(s) 410 may be configured to prevent a replay attack. For example, if a cryptogram has been obtained and replayed, that cryptogram is immediately rejected if the counter(s) 410 has been read or used or otherwise passed over. If the counter(s) 410 has not been used, it may be replayed. In some examples, the counter that is incremented on the card is different from the counter that is incremented for transactions. The contactless card 101 is unable to determine the application transaction counter(s) 410 since there is no communication between applet(s) 408 on the contactless card 102.

In some examples, the counter(s) 410 may get out of sync. In some examples, to account for accidental reads that initiate transactions, such as reading at an angle, the counter(s) 410 may increment but the application does not process the counter(s) 410. In some examples, when the mobile device 10 is woken up, NFC may be enabled and the device 110 may be configured to read available tags, but no action is taken responsive to the reads.

To keep the counter(s) 410 in sync, an application, such as a background application, may be executed that would be configured to detect when the mobile device 110 wakes up and synchronize with the server of a banking system indicating that a read that occurred due to detection to then move the counter 104 forward. In other examples, Hashed One Time Password may be utilized such that a window of mis-synchronization may be accepted. For example, if within a threshold of 10, the counter(s) 410 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 410 increases in the appropriate sequence, then it possible to know that the user has done so.

The key diversification technique discussed herein with reference to the counter(s) 410, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

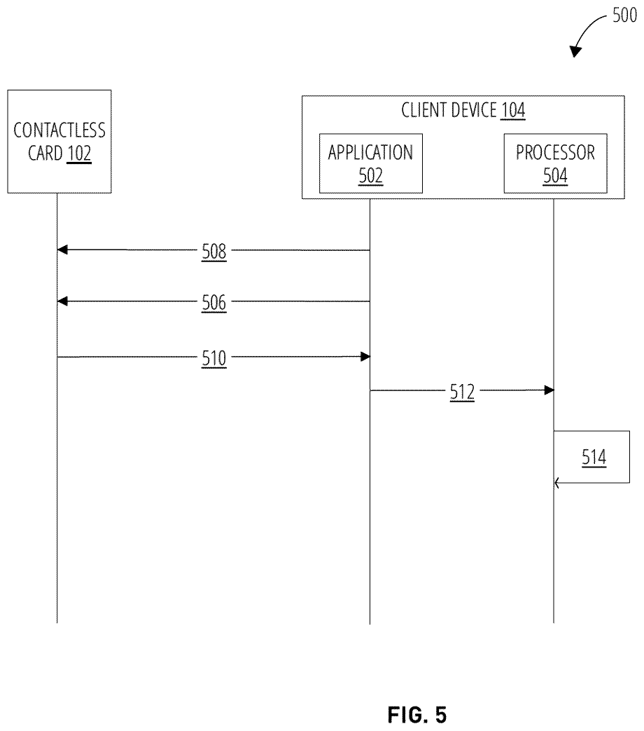

FIG. 5 is a timing diagram illustrating an example sequence for providing authenticated access according to one or more embodiments of the present disclosure. Sequence flow 500 may include contactless card 102 and client device 104, which may include an application 502 and processor 504.

At line 508, the application 502 communicates with the contactless card 102 (e.g., after being brought near the contactless card 102). Communication between the application 502 and the contactless card 102 may involve the contactless card 102 being sufficiently close to a card reader (not shown) of the client device 104 to enable NFC data transfer between the application 502 and the contactless card 102.

At line 506, after communication has been established between client device 104 and contactless card 102, contactless card 102 generates a message authentication code (MAC) cryptogram. In some examples, this may occur when the contactless card 102 is read by the application 502. In particular, this may occur upon a read, such as an NFC read, of a near field data exchange (NDEF) tag, which may be created in accordance with the NFC Data Exchange Format. For example, a reader application, such as application 502, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 502 may be configured to transmit a request to contactless card 102, the request comprising an instruction to generate a MAC cryptogram.

At line 510, the contactless card 102 sends the MAC cryptogram to the application 502. In some examples, the transmission of the MAC cryptogram occurs via NFC, however, the present disclosure is not limited thereto. In other examples, this communication may occur via Bluetooth, Wi-Fi, or other means of wireless data communication. At line 512, the application 502 communicates the MAC cryptogram to the processor 504.

At line 514, the processor 504 verifies the MAC cryptogram pursuant to an instruction from the application 122. For example, the MAC cryptogram may be verified, as explained below. In some examples, verifying the MAC cryptogram may be performed by a device other than client device 104, such as a server of a banking system in data communication with the client device 104. For example, processor 504 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

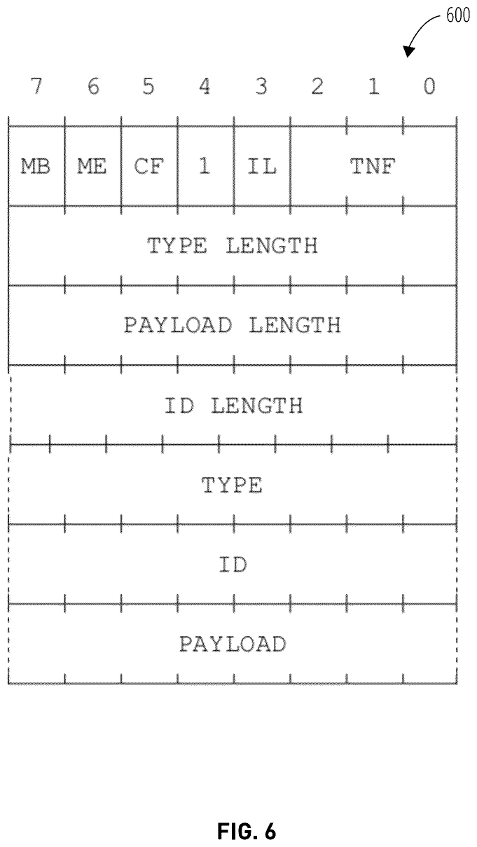

FIG. 6 illustrates an NDEF short-record layout (SR=1) data structure 600 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

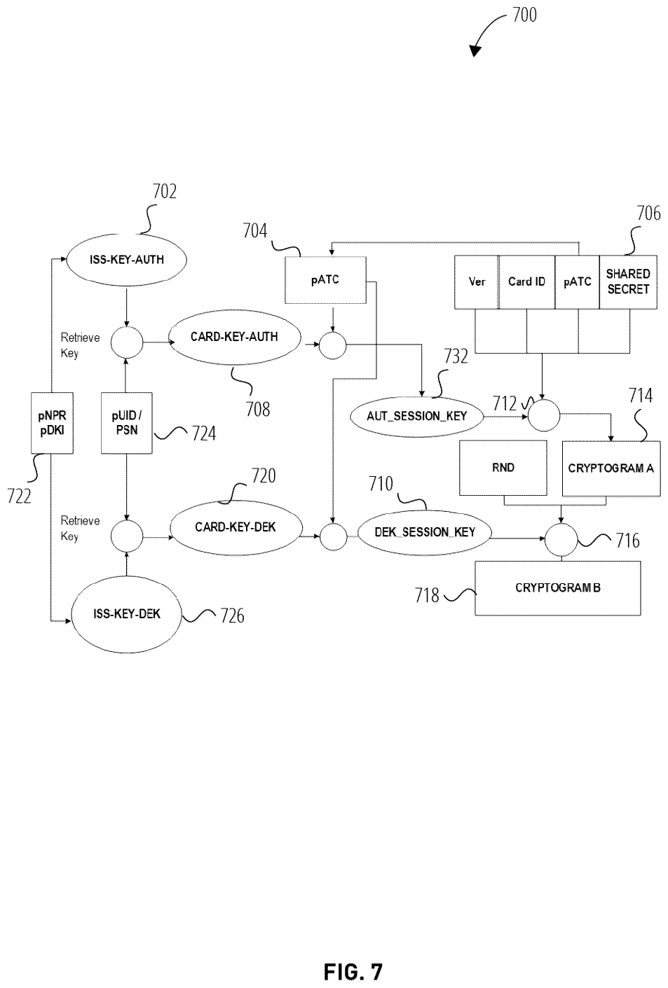

FIG. 7 illustrates a diagram of a system 700 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 702, 726 may be required for each part of the portfolio on which the one or more applets is issued. For example, the first master key 702 may comprise an Issuer Cryptogram Generation/Authentication Key (Iss-Key-Auth) and the second master key 726 may comprise an Issuer Data Encryption Key (Iss-Key-DEK). As further explained herein, two issuer master keys 702, 726 are diversified into card master keys 708, 720, which are unique for each card. In some examples, a network profile record ID (pNPR) 522 and derivation key index (pDKI) 724, as back office data, may be used to identify which Issuer Master Keys 702, 726 to use in the cryptographic processes for authentication. The system performing the authentication may be configured to retrieve values of pNPR 722 and pDKI 724 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As discussed herein, one or more MAC session keys may be derived using the lower two bytes of pATC 704 counter. At each tap of the contactless card, pATC 704 is configured to be updated, and the card master keys Card-Key-AUTH 508 and Card-Key-DEK 720 are further diversified into the session keys Aut-Session-Key 732 and DEK-Session-KEY 710. pATC 704 may be initialized to zero at personalization or applet initialization time. In some examples, the pATC counter 704 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 732, as explained above. As explained above, the low order two bytes of the counter may be used to diversify for the one or more MAC session keys. As explained below, AUT-Session-Key 732 may be used to MAC data 706, and the resulting data or cryptogram A 714 and random number RND may be encrypted using DEK-Session-Key 710 to create cryptogram B or output 718 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 710 derived from the Card-Key-DEK 720. In this case, the ATC value for the session key derivation is the least significant byte of the counter pATC 704.

The format below represents a binary version example embodiment. Further, in some examples, the first byte may be set to ASCII ‘A’.

Message Format

| 1 | 2 | 4 | 8 | 8 |
|---|---|---|---|---|
| 0x43 (Message | Version | pATC | RND | Cryptogram A |
| Type ‘A’) | | | | (MAC) |
| Cryptogram A | | | | |
| (MAC) | 8 bytes | | | |
| MAC of | | | | |
| 2 | 8 | 4 | 4 | 18 bytes input data |
| Version | pUID | pATC | Shared | |
| | | | Secret | |

Message Format

| 0x43 (Message | Version | pATC | | Cryptogram B |
|---|---|---|---|---|
| Type ‘A’) | | | | |
| Cryptogram A | | | | |
| (MAC) | 8 bytes | | | |
| MAC of | | | | |
| 2 | 8 | 4 | 4 | 18 bytes input data |
| Version | pUID | pATC | Shared | |
| | | | Secret | |
| Cryptogram B | 16 | | | |
| Sym Encryption of | | | | |
| 8 | 8 | | | |
| RND | Cryptogram A | | | |

Another exemplary format is shown below. In this example, the tag may be encoded in hexadecimal format.

| Message Format | | | | |
|---|---|---|---|---|
| 2 | 8 | 4 | 8 | 8 |
| Version | pUID | pATC | RND | Cryptogram A (MAC) |
| 8 bytes | | | | |
| 8 | 8 | 4 | 4 | 18 bytes input data |
| pUID | pUID | pATC | Shared | |
| | | | Secret | |

Message Format

| 2 | 8 | 4 | | 16 |
|---|---|---|---|---|
| Version | pUID | pATC | | Cryptogram B |
| 8 bytes | | | | |
| 8 | | 4 | 4 | 18 bytes input data |
| pUID | pUID | pATC | Shared | |
| | | | Secret | |
| Cryptogram B | 16 | | | |
| Sym Encryption of | | | | |
| 8 | 8 | | | |
| RND | Cryptogram A | | | |

The UID field of the received message may be extracted to derive, from master keys Iss-Key-AUTH 502 and Iss-Key-DEK 726, the card master keys (Card-Key-Auth 708 and Card-Key-DEK 720) for that particular card. Using the card master keys (Card-Key-Auth 508 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY, which yields cryptogram A 714 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. The input data 706 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, data 706 is processed through the MAC using Aut-Session-Key 732 to produce MAC output (cryptogram A) 714, which is encrypted.

In order to provide additional protection against brute force attacks exposing the keys on the card, it is desirable that the MAC cryptogram 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 510 to produce encrypted data, cryptogram B 718. The data 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

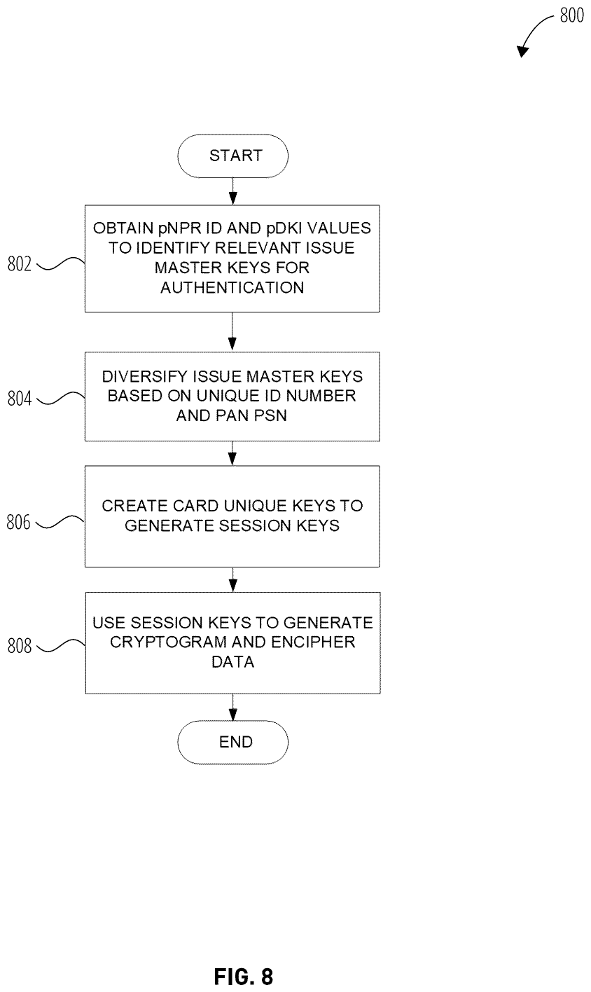

FIG. 8 illustrates a method 800 for generating a cryptogram. For example, at block 802, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 804, Issuer Master Keys may be diversified by combining them with the card's unique ID number (pUID) and the PAN sequence number (PSN) of one or more applets, for example, a payment applet.

At block 806, Card-Key-Auth and Card-Key-DEK (unique card keys) may be created by diversifying the Issuer Master Keys to generate session keys which may be used to generate a MAC cryptogram.

At block 808, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

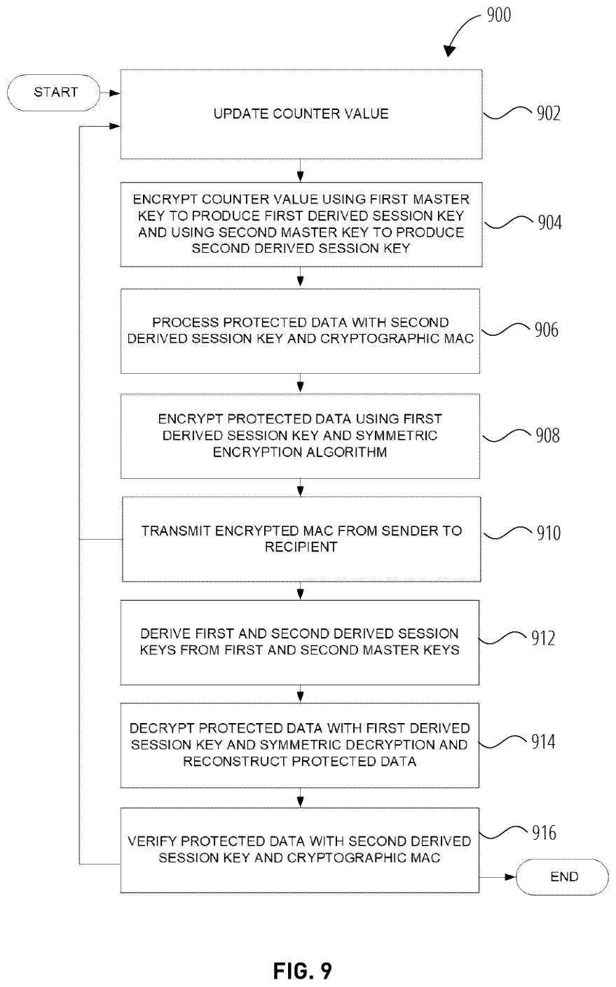

FIG. 9 depicts an exemplary process 900 illustrating key diversification according to an example embodiment. Initially, a sender and the recipient may be provisioned with two different master keys. For example, a first master key may comprise the data encryption master key, and a second master key may comprise the data integrity master key. The sender has a counter value, which may be updated at block 902, and other data, such as data to be protected, which it may secure share with the recipient.

At block 904, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 906, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 908, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 910, the encrypted MAC is transmitted, from the sender to the recipient, with sufficient information to identify additional secret information (such as shared secret, master keys, etc.), for verification of the cryptogram.

At block 912, the recipient uses the received counter value to independently derive the two derived session keys from the two master keys as explained above.

At block 914, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 916, the data integrity derived session key is used in conjunction with the cryptographic MAC operation to verify that the protected data has not been modified.

Some examples of the methods discussed herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 902) and a new set of session keys may be created (at block 910). In some examples, the combined random data may be discarded.

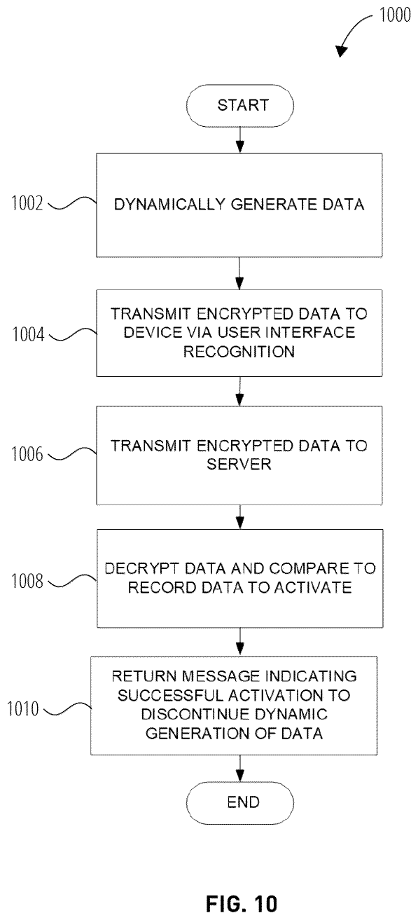

FIG. 10 illustrates a method 800 for card activation according to an example embodiment. For example, card activation may be completed by a system including a card, a device, and one or more servers. The contactless card, device, and one or more servers may reference same or similar components that were previously explained a, such as contactless card 102, client device 104, and a server.

In block, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1004, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1006, the one or more portions of the data may be communicated to one or more servers, such as a card issuer server. For example, one or more encrypted portions of the data may be transmitted from the device to the card issuer server for activation of the card.

In block 1008, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1010, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

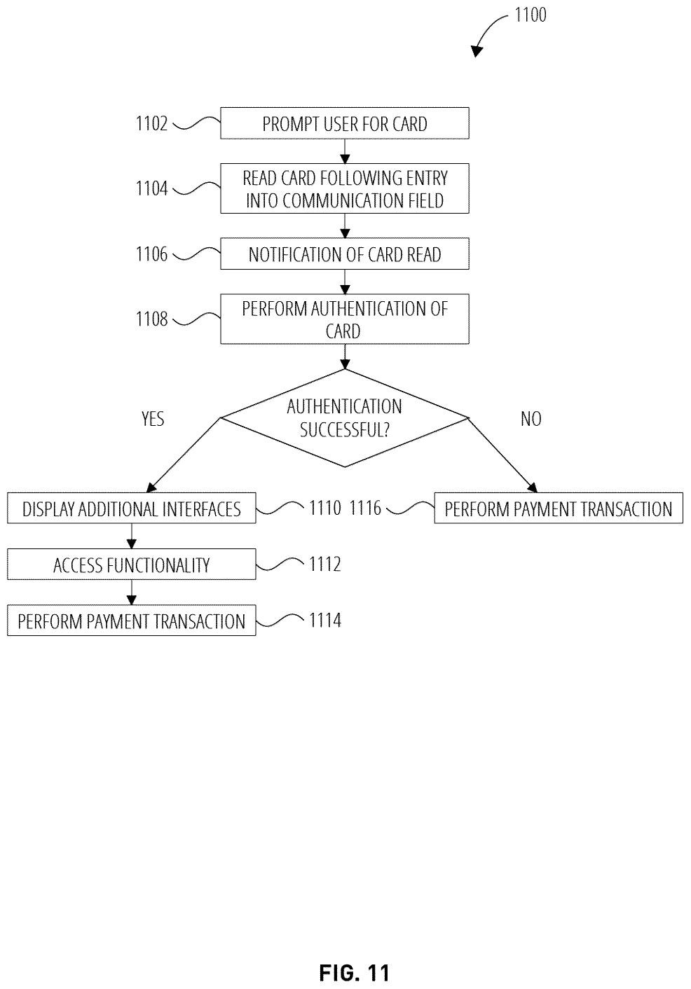

FIG. 11 illustrates an exemplary method 1100 for cryptographic authentication and functionality access for a contactless card. Exemplary embodiments of the method 1100 can be performed by a communication device (e.g., a network-enabled computer) interacting with a contactless card.

Method 1100 can begin at block 1102, where the communication device can display a prompt for a user to tap, swipe, or wave the contactless card in the vicinity of the communication device. The communication device can generate a communication field to enable contactless communication with the contactless card. The communication field can enable NFC, Bluetooth, Radio Frequency Identification (RFID), Wi-Fi, and/or another type of contactless communication.

In some examples, prior to prompting the user to tap, swipe, or wave the contactless card, the communication device can display a prompt the user to check the contactless card to see if the contactless card has the appropriate capabilities for use in the systems and methods discussed herein. Such capabilities can be indicated by a graphic, drawing, logo, marking, or other indicia on the card, or can be known to the user through his or her knowledge of an account associated with the contactless card. In other examples, the communication device does not display this prompt and instead the determination of whether the contactless card has the appropriate capabilities is performed once the contactless card has entered the communication field. If the contactless card does not have appropriate capabilities, the method 1100 can proceed to the performance of a payment transaction and/or another process for identification or verification.

Once the contactless card has entered into the communication field, in block 1104, secure communication between the contactless card and the communication device can begin. The communication device can read the contactless card and obtain data, such as by the processes discussed herein. Data exchanged between the contactless card and the communication device can include a data payload, a cryptogram, and/or other data discussed herein. The data exchanged between the contactless card and the communication device can be used to authenticate the contactless card, such as by the systems and methods discussed here in.

In block 1106, a notification signal that the contactless card has been read can be sent. The notification signal can include the data obtained from the contactless card. In some examples, the communication device contains an SoC, and the SoC can receive a notification signal. In other examples, the communication device does not contain an SoC, and the notification signal can be received by, e.g., a processor. Receipt of the notification signal can enable the SoC and/or the processor to perform the further functions and processes discussed herein.

In block 1108, the communication device can perform an authentication of the contactless card. The contactless card can be authenticated by the systems and methods discussed herein, for example.

If the authentication of the contactless card is successful, the method 1100 can proceed to block 1110. At block 1110, the communication device can display additional user interfaces. Exemplary user interfaces can include user interfaces seeking additional verification, user interfaces displaying data to the user, user interfaces for a point of access device, and user interfaces providing access to additional functionalities.

At block 1112, the communication device can provide access to one or more additional functionalities. As discussed herein, access to one or more additional functionalities can include, without limitation, access to entertainment content, sports content, other media content, discounts, promotions, loyalty benefits, rewards points, and/or other additional functionalities through the user's interaction with the communication device.

At block 1114, the communication device can perform a payment transaction. In some examples, the payment transaction can involve the contactless card and/or another account associated with the contactless card and/or the user associated with the contactless card. If necessary, the communication device can prompt for a second tap, swipe, or wave of the contactless card into the communication field of the communication device. In some examples, the payment transaction can include a Europay, Mastercard, and Visa (EMV) transaction. In examples where one or more additional functionalities were accessed, the payment transaction can reflect this access.

Returning to block 1108, if the authentication of the contactless card is unsuccessful, the method 1100 can proceed to block 1116, where the communication device can perform a payment transaction, as discussed herein.

As discussed herein, communication devices can display one or more user interfaces. Exemplary user interfaces can include user interfaces seeking additional verification. Exemplary user interfaces seeking additional verification can include, without limitation, user interfaces requesting submission of login credentials (e.g., username, phone number, account number, password, one-time password, personal identification number (PIN)), user interfaces requesting age verification (e.g., submission of driver's license), user interfaces requesting address information, and user interfaces requesting biometric information (e.g., facial scans, fingerprint scans, retina scans, voice input).

Exemplary user interfaces can include user interfaces displaying data. Exemplary user interfaces displaying data can include, without limitation, user interfaces displaying data relating to a user card account, such as a credit card, debit card, or gift card (e.g., account balances, transaction history, pending available funds, available credit), user interfaces displaying data relating to loyalty or rewards account (e.g., reward points balances, point redemption options, past point redemptions, loyalty status), user interfaces displaying data relating to a merchant account, such as a goods provider, or services provider (e.g., a retailer account, an online vendor account, a subscription service, an entertainment venue account for sports, movies, or music), user interfaces displaying data relating to a utilities account (e.g., an electric utility account, a water utility account, a gas utility account), user interfaces displaying data relating towards a user financial account such as a savings, checking, or brokerage account (e.g., account balances, deposits, withdrawals, transaction activities, pending transactions, bills due, bill payment activity), user interfaces displaying data relating to a travel account (e.g., tickets, schedules, upcoming bookings, past trips), and user interfaces presenting data relating to a point of access account, such as a building access account, a storage access account, and a vehicle access account (e.g., status of access, current permissions, access history, upcoming new access permissions, upcoming access permission expirations).

Exemplary user interfaces can include user interfaces providing access to additional functionalities. Exemplary user interfaces providing access to additional functionalities can include, without limitation, user interfaces displaying content, rewards, or other information. Exemplary user interfaces displaying content can include, without limitation, user interfaces displaying entertainment content (e.g., movies, music, music videos, television shows, comedy acts, plays, whether live or previously recorded), user interfaces displaying sports content (e.g., professional sports games, collegiate sports games, sports highlights, whether live or previously recorded), and other media content (e.g., news programs, documentaries, trivia). Exemplary user interfaces providing access to rewards can include, without limitation, user interfaces displaying rewards information (e.g., the application of rewards points to a transaction, the accrual of rewards points for a transaction), loyalty program information (e.g., loyalty program status, reward points balances, frequent flyer mile balances, redemption options, past redemptions, loyalty status).

Exemplary user interfaces can include user interfaces for point of access devices. Exemplary user interfaces for point of access devices can include, without limitation, user identification interfaces, user input interfaces (e.g., input of login credentials, bar code scanning, quick response code scanning), biometric user interfaces (e.g., facial scans, fingerprint scans, retina scans, voice input), photographic input interfaces (e.g., to capture an image and/or video of the user).

As discussed herein, communication devices can provide access to additional functionalities. Additional functionalities can include access to accounts and the ability to conduct transactions using the accounts, including, without limitation, access to a credit card, debit card, or gift card, loyalty or rewards account, a merchant account, such as a goods provider, or services provider (e.g., a retailer account, an online vendor account, a subscription service, an entertainment venue account for sports, movies, or music), a utilities account (e.g., an electric utility account, a water utility account, a gas utility account), a financial account such as a savings, checking, or brokerage account (e.g., account balances, deposits, withdrawals, transaction activities, pending transactions, bills due, bill payment activity), a travel account (e.g., tickets, schedules, upcoming bookings, past trips), and a point of access account (e.g., status of access, current permissions, access history, upcoming new access permissions, upcoming access permission expirations), and any combination thereof.

Additional functionalities further can include, without limitation, access to entertainment content (e.g., movies, music, music videos, television shows, comedy acts, plays, whether live or previously recorded), sports content (e.g., professional sports games, collegiate sports games, sports highlights, whether live or previously recorded), other media content (e.g., news programs, documentaries, trivia), rewards (e.g., the application of rewards points to a transaction, the accrual of rewards points for a transaction), loyalty program information (e.g., loyalty program status, reward points balances, frequent flyer mile balances, redemption options, past redemptions, loyalty status), discounts and/or promotions applicable to current, past, or future transactions, access to a building, room, locker, storage unit, vehicle (e.g., an automobile, a truck, a bus, a ship, a boat, an airplane, a helicopter), and any combination thereof.

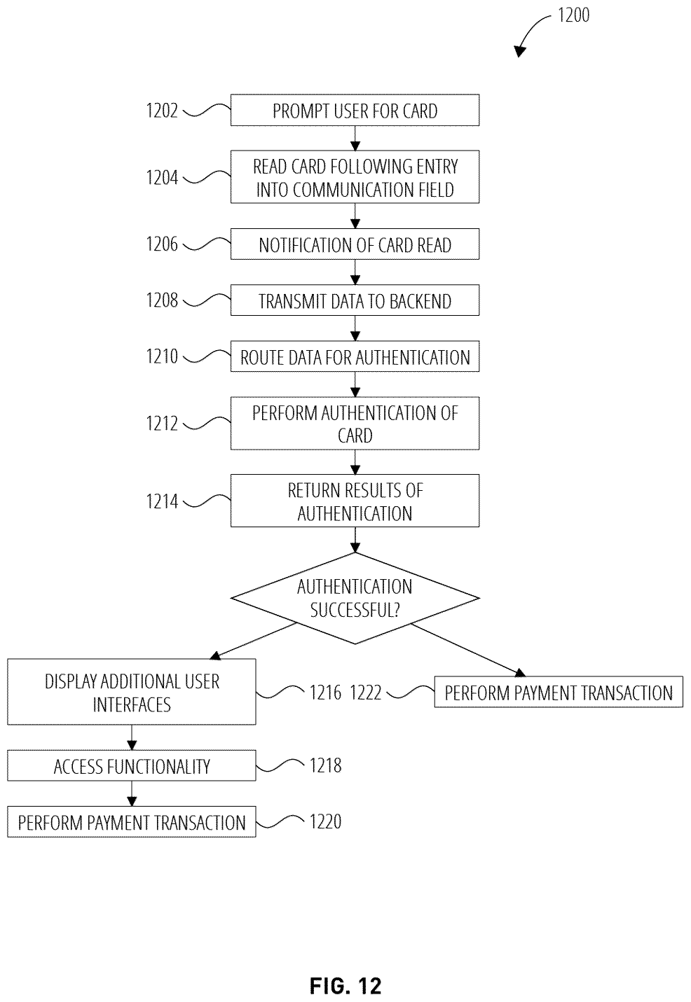

FIG. 12 illustrates an exemplary method 1200 for cryptographic authentication and functionality access for a contactless card. Exemplary embodiments of the method 1100 can be performed by a communication device (e.g., a network-enabled computer) interacting with a contactless card and with a backend and/or other devices.

Method 1200 can begin at block 1202, where the communication can display a prompt for a user to tap, swipe, or wave the contactless card in the vicinity of the communication device. The communication device can generate a communication field to enable contactless communication with the contactless card. The communication field can enable NFC, Bluetooth, Radio Frequency Identification (RFID), Wi-Fi, and/or another type of contactless communication.

In some examples, prior to prompting the user to tap, swipe, or wave the contactless card, the communication device can display a prompt the user to check the contactless card to see if the contactless card has the appropriate capabilities for use in the systems and methods discussed herein. Such capabilities can be indicated by a graphic, drawing, logo, marking, or other indicia on the card, or can be known to the user through his or her knowledge of an account associated with the contactless card. In other examples, the communication device does not display this prompt and instead the determination of whether the contactless card has the appropriate capabilities is performed once the contactless card has entered the communication field. If the contactless card does not have appropriate capabilities, the method 1200 can proceed to the performance of a payment transaction and/or another process for identification or verification.

Once the contactless card has entered into the communication field, in block 1204, secure communication between the contactless card and the communication device can begin. The communication device can read the contactless card and obtain data, such as by the processes discussed herein. Data exchanged between the contactless card and the communication device can include a data payload, a cryptogram, and/or other data discussed herein. The data exchanged between the contactless card and the communication device can be used to authenticate the contactless card, such as by the systems and methods discussed herein.

In block 1206, a notification signal that the contactless card has been read can be sent. The notification signal can include the data obtained from the contactless card. In some examples, the communication device contains an SoC, and the SoC can receive a notification signal. In other examples, the communication device does not contain an SoC, and the notification signal can be received by, e.g., a processor. Receipt of the notification signal can enable the SoC and/or the processor to perform the further functions and processes discussed herein.

In block 1208, the communication device can transmit the data obtained from the contactless card to a backend. The backend can comprise, e.g., one or more receiving devices and/or a network-enabled computers, such as one or more servers in data communication with the communication device. The backend can determine where to route the data obtained from the contactless card for authentication, such as to one or more receiving devices and/or network-enabled computers associated with particular entities, such as an issuing entity and/or a validator entity, for performance of the authentication, and in block 1210, the data can be routed accordingly as discussed herein.

In block 1212, the one or more receiving devices and/or network-enabled computers receiving the data obtained from the contactless card can perform an authentication of the contactless card. The contactless card can be authenticated by the systems and methods discussed herein, for example. In block 1214, the results of the authentication of the contactless card can be transmitted to the backend and returned to the communication device. Blocks 1208, 1210, 1212, and 1214 of the method 1200 can be performed by the systems and methods discussed herein.

If the authentication of the contactless card is successful, the method 1200 can proceed to block 1216. At block 1216, the communication device can display additional user interfaces. Exemplary user interfaces can include user interfaces seeking additional verification user interfaces displaying data to the user, user interfaces for a point of access device, and user interfaces providing access to additional functionalities.

At block 1218, the communication device can provide access to one or more additional functionalities. As discussed herein, access to one or more additional functionalities can include, without limitation, access to entertainment content, sports content, other media content, discounts, promotions, loyalty benefits, rewards points, and/or other additional functionalities through the user's interaction with the communication device.

At block 1220, the communication device can perform a payment transaction. In some examples, the payment transaction can involve the contactless card and/or another account associated with the contactless card and/or the user associated with the contactless card. If necessary, the communication device can prompt for a second tap, swipe, or wave of the contactless card into the communication field of the communication device. In some examples, the payment transaction can include a Europay, Mastercard, and Visa (EMV) transaction. In examples where one or more additional functionalities were accessed, the payment transaction can reflect this access.

Returning to block 1214, if the authentication of the contactless card is unsuccessful, the method 1200 can proceed to block 1222, where the communication device can perform a payment transaction, as discussed herein.

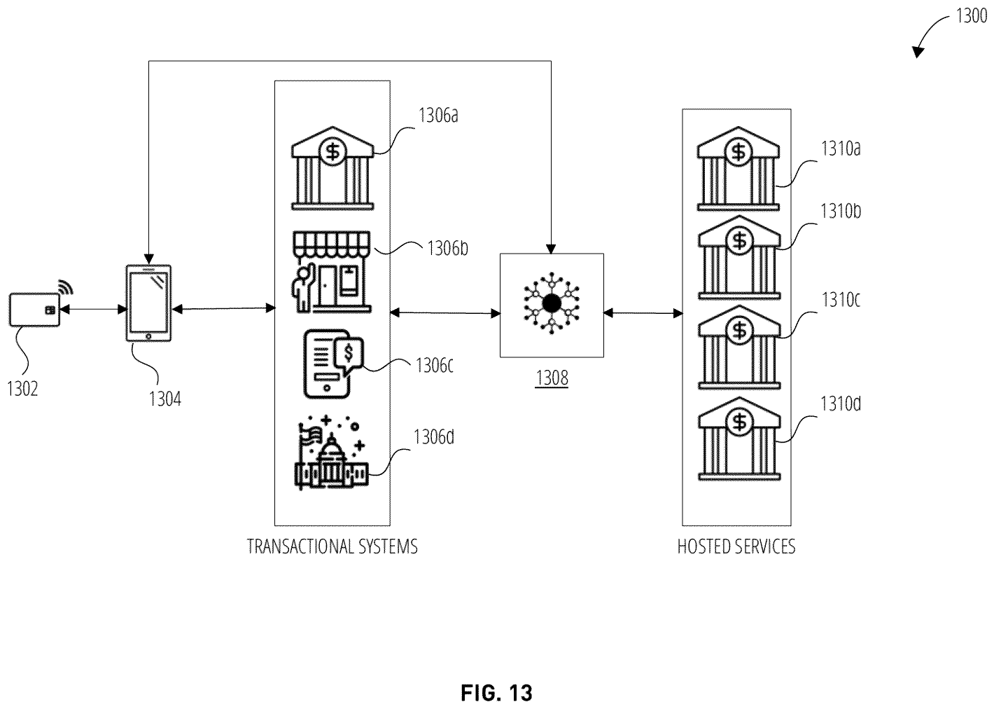

FIG. 13 illustrates an example of a multi-issuer system 1300 configured to operate in accordance with embodiments discussed herein. The system 1300 may include computing systems configured to enable functions to be performed with contactless cards, such as the contactless card 1302 and cryptographic techniques discussed herein. These functions may include performing transactions, and other functions, such as verification of the user, and tap-to functions. Tap-to functions may include tap to autofill fields on a mobile device, tap to launch applications on a mobile device, tap to open doors, tap to activate a card, and other tap to operations.

System 1300 illustrates a high-level configuration that enables multiple users to use contactless cards issued by one or more issuers to perform operations including transactions with merchant systems. In the illustrated example, system 1300 includes a number of banking systems 1306a, retail systems 1306b, other financial systems 1306c, and government systems 1306d. These transactional systems may be configured for users to perform transactions to purchase goods and services with contactless cards. Additionally, these systems may be configured to provide verification services to the customer via their contactless cards. Embodiments are not limited in this manner.

The system 1300 may be configured to perform various operations for customers, issuing banks, merchants, etc. These operations may be initiated by the customer using the contactless card 1302 causing an exchange of information between the contactless card 1302 and the other systems of system 1300. Depending on which operation is being performed, e.g., tap to launch an application, tap to autofill text, tap to authenticate, tap to perform a transaction, etc., data may be routed and sent to the various systems of the system 1300 to perform their respective operations.

For example, a contactless card 1302 may initiate a transaction with one of the merchant systems when tapped on another device, such as mobile device 1304, that may be further configured to communicate with one of the other systems, such as the hosted service(s). These services may include verification services and commerce services. However, embodiments are not limited in this manner. Other services may be configured to perform operations such that a customer can perform any number of tap to functions.

As will be discussed in more detail the mobile device 1304 may communicate data from the contactless card 1302 to another system(s), such as one or more of the services 110 that are configured to provide transaction services and other operations. The data may be routed to a particular service 110 by the switchboard system 1308 in a secure encrypted manner, as will be discussed herein. In embodiments, the data may be provided in a cryptogram.

To provide services in a multi-issuer environment, the system 1300 includes a switchboard system 1308 or hub system configured to communicate data between the systems (bank, retailer, other financial institutes, government, etc.) and participating bank's backend processing services. The switchboard system 1308 enables any number of banks and different financial institutions to issue contactless cards with transactional functionality, verification functionality, and so forth and operate seamlessly to perform operations while maintaining a high level of security with sensitive data. As will be discussed in more detail, the switchboard system 1308 enables mobile devices, and merchant systems a central system of communication to communicate with many issuing banks' data to perform transactions and other functions.

For example, a customer may wish to perform a transaction for a goods or service (retailer system 1306b). The customer may initiate the transaction via their mobile device or interaction with a point-of-sale (POS) terminal. The device or terminal may send a message for the transaction to the switchboard system 1308, which may determine how further to process the message and complete the transaction. The message may include an encrypted portion and an unencrypted portion. The encrypted portion may include sensitive data that may be used by the issuing banking system functions to process the transaction, and the unencrypted portion may include data that may be used by the switchboard system 1308 to route the message and data to the correct issuing banking system functions via application programming interfaces and services, such as commerce services. The switchboard system 1308 may communicate with mobile device 1304 and then with the merchant backend system (106) to first verify the contactless card and the user, establish a commerce session between the mobile device, commerce services, and a merchant system, and enable performance a transaction in a secure manner.

In embodiments, a switchboard system 1308 may also include administrative services that may be utilized to onboard card issuers, validators, and merchants onto the system to provide the contactless card services. In one example, the switchboard system may onboard an issuer/validator by generating a unique identifier to identify the issuer/validator and storing a mapping between the unique identifier and issuer/validator in a data store, such as validation HSM. The unique identifier may also be provided to an issuer system such that the issuer may provide the unique identifier on each contactless card to provide during transactions and other operations.

Any number of banks or financial institutions may provide a number of services 110 or functions that may be utilized by the customers, merchants, and the banks to provide services 110 including processing transactions and verifying customers and their contactless cards. These services may include validation services and commerce services. These services may be hosted on a central platform, such as a cloud-based system, and each bank may have its own set of services. Further, each bank's services 110 may be hosted by the same central platform and the switchboard system 1308 may determine which bank's services 110 to call via an API based on information in the messages.

In embodiments, the system 1300 may also perform onboarding operations to onboard merchants and merchant systems to operate with the switchboard system 1308 environment. In embodiments, onboarding a merchant may include generating a unique identifier associated with the merchant and providing the unique identifier to the merchant, e.g., issuing a merchant certificate. The system 1300 may also enable merchants and issuers to exchange data, such as key pairs to securely perform operations without sensitive data being revealed to the switchboard system 1308. System 1300 may also enable merchants to configure and set one or more configurations, such as configuring data fields to support merchant use cases.

The system 1300 may also perform onboarding operations for card issuers. For example, the system 1300 may enable banks or card issuers to generate a unique identifier, e.g., issuer id, that may be used to uniquely identify the issuer when performing validation and other functions. The system 1300 may also enable a bank or issuer to generate and/or distribute key pairs with merchants and other service providers. These and other details will be described in the following description.

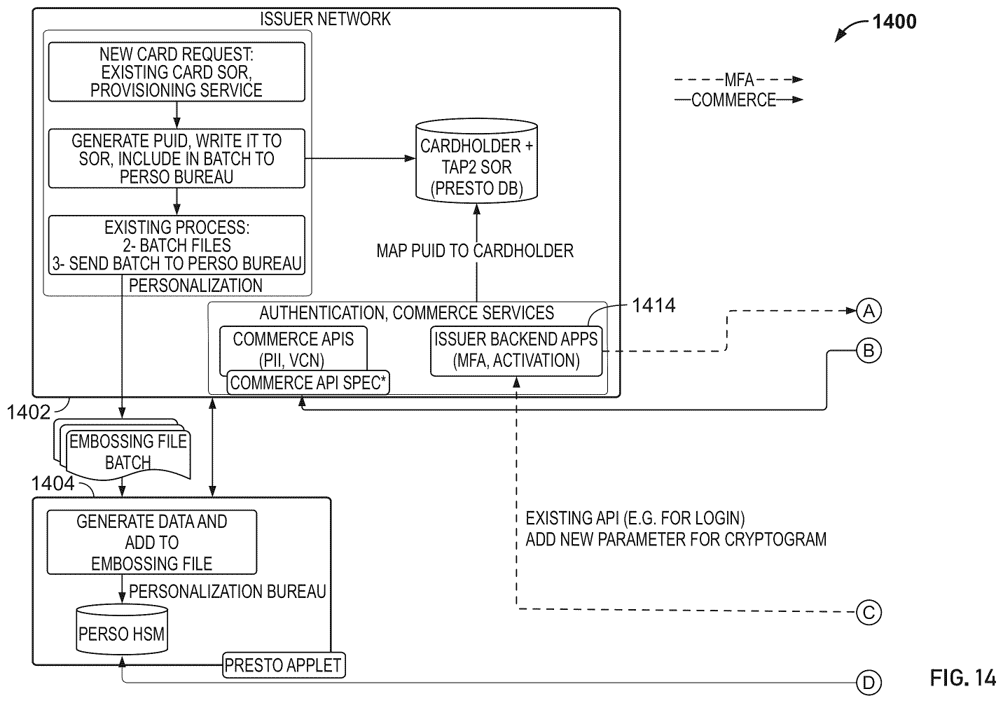

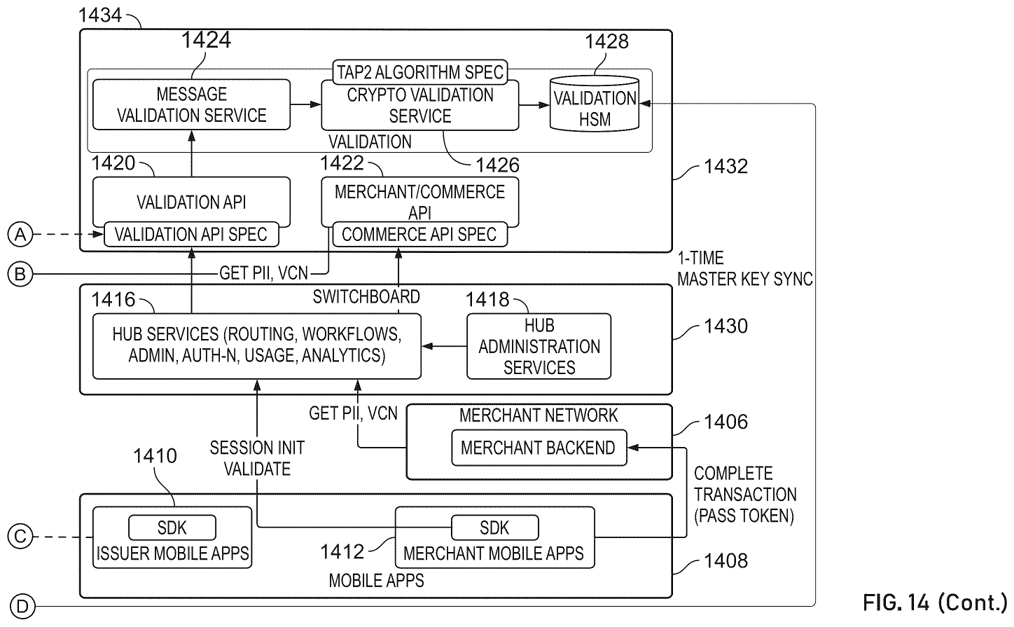

FIG. 14 illustrates an example of a system 1400 configured in accordance with embodiments discussed herein. In some instances, the system 1400 may be a more detailed view of system 1300 and its components. The illustrated system 1400 includes one or more systems to support processing transactions, performing validation functions, and other functions involving contactless cards issued in a multiple issuer environment. In embodiments, the system 1400 includes one or more issuer systems 1402, a personalization system 1404, one or more merchant systems 1406, and a switchboard system 2808. The switchboard system 2808 may include additional systems to provide the functionality to a plurality of issuer systems, these systems may include a hub network and a validation system.

These systems may be configured with hardware and software components to perform the functions discussed herein. For example, each system may be configured with one or more servers, processors, memory, storage, networking hardware, input/output devices, etc., to process instructions in accordance with embodiments. Moreover, each of the systems may support and implement a number of application programming interfaces (APIs) configured to enable interoperability between each of the systems while maintaining a high level of security.

In embodiments, the system 1400 includes at least one issuer system 1402. An issuer system 1402 may have a number of components and provide the functionality to issue contactless cards to customers, authenticate customers, perform transactions, and enable other contactless card tap-to operations. In one example, the issuer system 1402 includes functions to issue cards including processing network contactless card requests, maintaining a system of record (SoR), and providing provisioning services.

In one example, to issue cards, the issuer system 1402 may generate card unique identifiers (pUIDs), each of which may be associated with a cardholder and a contactless card when issued. A pUID may be utilized as a part of a validation process and the issuer system 1402 may store the pUIDs in a database associated with cardholders, for example. The pUIDs may be written to SoRs and provided to the personalization system 1404 to physically generate and issue the contactless cards. In some instances, the pUIDs may be communicated to the personalization system 1404 in batch or a batch file. For example, the issuer system 1402 may include a process to generate a batch of pUIDs, and a function to communicate the batch, e.g., embossing file batch, to the personalization system 1404. The personalization system 1404 may configure and physically generate and issue the contactless cards, as will be discussed in more detail below.

In some embodiments, the issuer system 1402 may provide additional functionality. In some instances, the issuer system 1402 may maintain at least a portion of functionality to perform validation operations for customers once contactless cards have been issued. For example, the issuer system 1402 may include functions and APIs that devices, such as a mobile device executing an issuer mobile app 1410 may use to validate information originally received from the contactless card. The device may communicate the data from the contactless card to the issuer system 1402 via one or more APIs, such as those provided by the MFA service 1414, and the issuer system 1402 may validate the information based on information stored in a database. The issuer system 1402 may return a result to the device.

In other instances, the issuer system 1402 may offload the validation operations to the switchboard system 1430. In these instances, the issuer system 1402 may still receive the data from the contactless card via a device, e.g., a mobile device, and through an API. The issuer system 1402 may then be configured to send the data to the switchboard system 1430, and the switchboard system 1430 may perform the validation operations. In either case, the issuer system 1402 may return a result of the validation to the device. The device, such as a mobile device, may use the result as a part of a validation request, e.g., to access a mobile app, as part of a multifactor authentication operation, or enable the performance of another function.

In embodiments, the system 1400 includes a personalization system 1404 to perform operations on contactless cards to issue them to customers. For example, the personalization system 1404 may obtain and/or generate data that may be copied to each contactless card for each customer. The data may be unique to each customer and include information such as an account number, a customer's name, an expiration date, a card verification value (CVV), etc. In embodiments, the personalization system 1404 may store the data in a secure memory, such as a hardware security module (HSM) of a contactless card. The data may also be provided to the issuer system 1402 and/or the switchboard system 1430 such that they can perform contactless card operations, e.g., validation, authentication, tap-to, etc. . . .

The personalization system 1404 may also generate unique keys for each of the contactless card. Each of the contactless card may have a unique pair of keys that may be further used to generate derived keys that are used to perform cryptographic operations for the card to communicate data in a secure manner. Each of the card's unique keys may be based on and/or associated with the issuer bank, e.g., via the bank identification number (BIN). In addition, the issuer system 1402 and/or the switchboard system 1430 may have each card's unique set of keys that they may use to perform validation operations by being able to generate the same derived keys to decrypt the data received from the contactless card during a validation or transaction process.

The personalization system 1404 may also install one or more applets on the card. The applets may be used to perform various functions including performing cryptographic operations and generating a message and cryptogram including data to perform card verification and transactions. In some instances, the personalization system 1404 may install an applet to perform functions and include an applet version number. System versioning may be required such the other systems can operate accordingly. The system version dictates the applet version to embed in the cards by the personalization system 1404 as well as the validation logic. For example, first-party systems may operate under version 0100, and utilization of a central system may operate under a different version, e.g., version 0200, to simplify the implementation and enable an authentication network. JavaCard and MultOS implementations of the applet may share the same version number.

The personalization system 1404 may also include additional applets to perform additional functions. For example, each card may include an applet configured to communicate with other devices either wired and/or wirelessly. In some instances, the communication may be based on the Europay, Mastercard, Visa, (EMV) standard, ISO/IEC 7816 standard for contact cards, and standards based on ISO/IEC 14443 contactless cards.

The system 1400 further includes a switchboard system 1430 to enable multiple banks or issuers to provide contactless card tap-to-perform functionality, e.g, validation, transactions, etc., while maintaining a high level of data security and separation between each of the issuer's data. For example, the switchboard system 1430 provides a set of functions and APIs configured to provide services to multiple issuers to perform validation, transaction, and other contactless card operations. In some instances, the switchboard system 1430 may be maintained and provided by a central system that is owned and operated by a separate entity from any of the card issuers.

In embodiments, the switchboard system 1430 may include a number of components, and systems include a switchboard system 1430 and validation system 1432. The switchboard system 1430 may include a set of hub services 1416 such as routing services, workflow services, administrative services, authentication services, usage services, analytics services, and hub admin services 1418.

In embodiments, the switchboard system 1430 and services are configured to enable the multiple issuers to operate together. For example, the switchboard system 1430 is configured to route messages and data from devices and contactless cards to the cards issuer's corresponding services. For example, bank A may issue a contactless card and provide services A, the switchboard system 1430 is configured to process messages and data from the contactless card issued by bank A to services A. In embodiments, the switchboard system 1430 may utilize information in the messages and data to determine where to send them.

The switchboard system 1430 and services also enable merchant systems 1406 to process transactions for multiple and different issuers. For example, the switchboard system 1430 may include an API that may be used by a merchant backend to get PII and a VCN associated with a cardholder to perform a transaction. The switchboard system 1430 may also include an API configured to initiate a session, e.g., a transaction session, and provide a validation token to a merchant app on a mobile device based on a contactless card performed on a mobile device.

The switchboard system 1430 also includes validation functions and validation APIs, e.g., validation services 1420, to perform validation operations, and commerce services 1422 including functions and APIs to perform transaction services. The switchboard system 1430 may also include a message validation service 1424 configured to communicate with the validation functions/APIs to provide cryptogram validation services 1426. The cryptogram validation services 1426 include a tap algorithm and are coupled with the validation HSM 1428 to perform validation operations. Each of the APIs are discussed in more detail in the following description.

In embodiments, the system 1400 includes a number of systems to provide functionality and services utilizing contactless cards. At least a portion of these services may be performed with a contactless card and another device, such as a mobile device. As will be discussed in more detail, a mobile device may execute one or more apps that may be configured to operate with the functions and APIs provided by the system 1400. In one example, the one or more apps may be developed utilizing a software development kit including instructions and functions to operate with the functions and APIs. The mobile apps may include an issuer mobile app 1410, such as a banking app, and merchant mobile app 1412. However, embodiments are not limited in this manner, and other applications such as web browsers, mini or micro apps (e.g., app clips), an operating system, and so forth may be configured to operate and utilize the functionality provided by the system 1400.

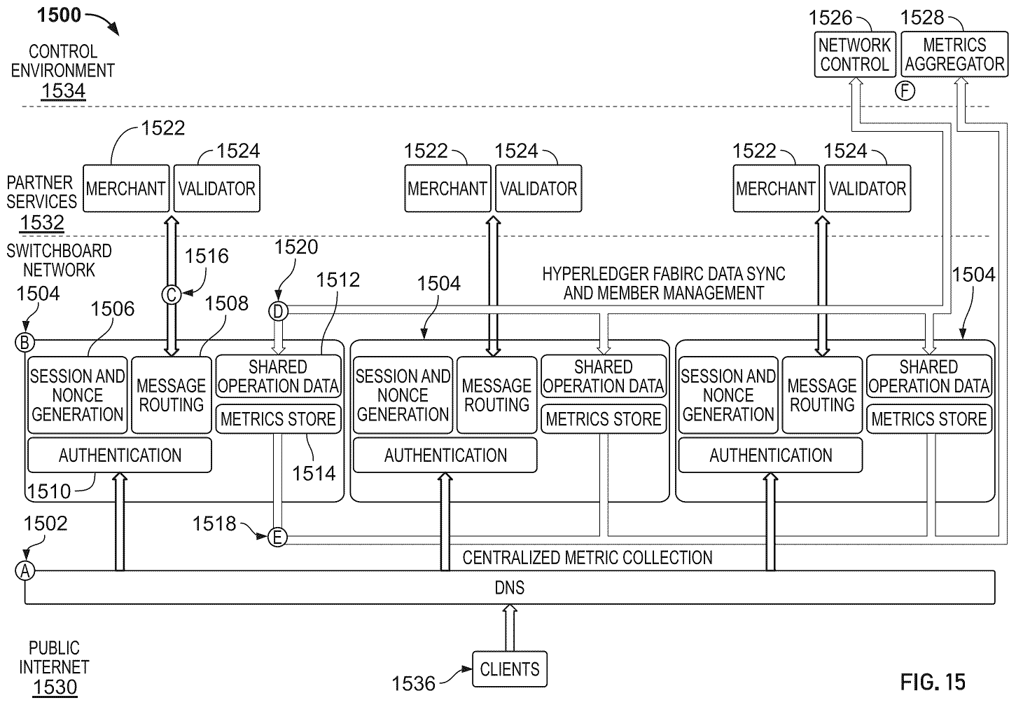

FIG. 15 illustrates an example of system 1500 in accordance with the embodiments discussed herein. The system 1500 includes additional devices and systems configured to enable contactless card issuers to tap-to-card services. Specifically, system 1500 enables any number of issuer systems to provide card services to their clients through a switching fabric, i.e., the switchboard system in a secure and safe manner.

In embodiments, the switchboard system includes one or more nodes 1504 configured to perform routing operations. Each switchboard node 1504 may include a session and nonce generator 1506, a message router 1508, a 1510, an operation data 1512 store, and a metrics store 1514. Further, each of the nodes may be configured the same and share configurations, but each switchboard node 1504 may independently process and route messages and requests to the appropriate systems, such as the merchant systems and issuer systems. Each of the nodes 1504 is configured to act as a broker of trust between an issuer system, the merchant system 1522, and/or validation system 1524, for example. Each switchboard node 1504 is configured to route each message to the correct issuer system while maintaining data security. For example, a switchboard node 1504 may route a message between an issuer system and merchant system while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 1504. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

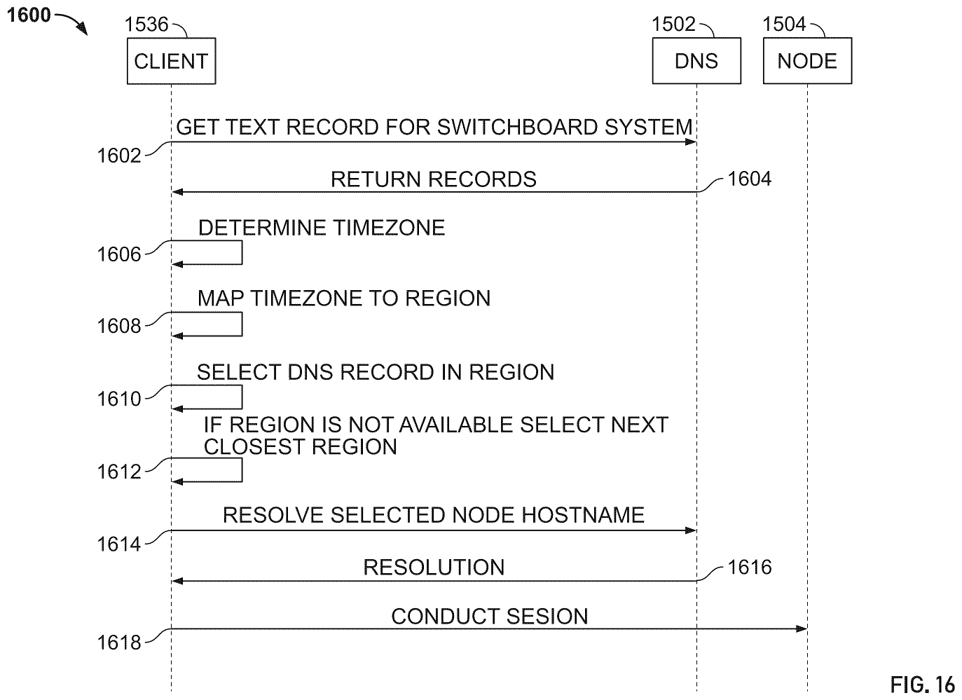

In some embodiments, the nodes 1504 may operate in a cloud-based computing environment, e.g., a collection of hardware, software, and networking components that enable the delivery of cloud computing services. The switchboard nodes 1504 and the computing services are delivered over the Internet, and they can be accessed from anywhere in the world with an Internet connection. In embodiments, a client 1536 may access a switchboard node 1504 through Domain Name System 1502 or domain name system (DNS). The DNS 1502 a hierarchical and distributed naming system for computers, services, and other resources connected to the Internet or other networks. It associates various information with domain names assigned to each registered participant. In one example, the DNS 1502 may translate a name known to software executing on a client 1536 to route data to one or more of switchboard node 1504 of the switchboard system. In embodiments, the DNS 1502 may generate into a number, such as an Internet Protocol (IP) address, an address record (A-record), or another Host name (C-name record). FIG. 16 illustrates one example sequence 1600 for a client to identify and resolve an identifier for one of the nodes 1504 of the switchboard system. At a high level, the Domain Name System 1502 translates known domain names to numerical Internet Protocol (IP) addresses needed for locating and identifying computer services and devices with the underlying network protocols. Clients use the global DNS system to select the best node to use, as discussed in the sequence 1600.

In embodiments, a client 1536 communicates with the switchboard system to perform one or more of the partner services 1532, such as conducting a transaction with a merchant, validate the customer, or other tap-to functions. Once the client 1536 identifies a switchboard node 1504 and resolves an address to communicate with the switchboard node 1504, the client 1536 may send one or more messages to the switchboard node 1504 to authenticate and perform the operation. The switchboard node 1504 includes an authentication 1510 function that is configured to authenticate the client 1536. In embodiments, the client 1536 sends a message or authorization request to the switchboard node 1504 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client | Individual |
| | ID | identifier |
| | | of client |
| GReyx5BuEAaE72bWbFZ.IfHRL8DbtUum | Client | Randomly |
| | Key | assigned key |

The switchboard node 1504 may authorize or authenticate the client 1536 or user, and the switchboard node 1504 may utilize the additional components, such as the session and nonce generator 206 and message router 208, to perform the operations. Note the Validators validation systems 224 never interact with the merchant systems 222, nor vice versa. The nodes 204 brokers all communication.

In embodiments, the switchboard system may utilize a hyperledger fabric 1520 to manage synchronizing the shared operation data 1512 and member management across the network. The hyperledger fabric 1520 is distributed ledger framework having a permissioned network model that only authorized participants can join the network and access the data that is stored on a ledger.

In embodiments, the hyperledger fabric 1520 may be generated by creating one or more set of peers, an ordering service, and a channel. Once the network is created, the system 1500 deploys chaincode to the network or nodes 1504 permitted to access the fabric. The chaincode is the code that runs on the blockchain and executes the network control 1526 and operation data 1512 logic code. Once the chaincode is deployed, each of the switchboard nodes 1504 is configured to invoke transactions on the blockchain to add data to the blockchain, e.g., the operational data. A switchboard node 1504 or another device can query the ledger to retrieve data. The ledger is a distributed database that stores all of the data that has been added to the blockchain.

All nodes 1504 keep an independently verifiable log of their actions that can be transmitted to a centralized aggregator to build a picture of overall network usage. At a central level, system 1500 can manage network operation data and management and have a centralized view of network use, aggregated and abstracted to the appropriate level.

FIG. 16 illustrates an example sequence 1600 for a client to utilize DNS to resolve and communicate with one or more nodes of a switchboard system. The illustrated sequence 1600 includes a client 1536, a DNS 1502, and a switchboard node 1504. At 1602, the sequence 1602 includes the client 1536 sending a request to a default DNS server for a text record switchboard. {domain}.{tld}. The text record may be preconfigured in a client app and/or client sdk. At 1604, the DNS 1502 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node 1504

In embodiments, the client 1536 may determine the current timezone at 1606. For example, the client app or sdk may utilize a get current timezone function, such as in JavaScript: Intl.DateTimeFormat( ).resolvedOptions( ).timeZone). Embodiments are not limited in this manner, and the app or sdk may determine the timezone via another/different function call. At 1608, the client 1536 is configured to map the timezone to a region or short-version identifier of the region. One example includes America/New_York→na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1610, the client may identify or select a DNS record option returned at 1604 that is in the region. If there are multiple matches, the client may select one at random. If there's no node available in a region, the client may determine and use a data graph of neighboring regions to select a node in the closest region where a node is available at 1612. For example, sa has no node but is connected to na-e where there is a node and so na-e is selected. In some embodiments,

At 1614, the client may resolve a selected node's hostname. In embodiments, the client 1536 may automatically resolve the hostname using the client's HTTP request default resolver. At 1616, the Domain Name System 1502 may return a result. And at 1618, the client 1536 may communicate with a switchboard node 1504 and begin the process to interact with the switchboard.

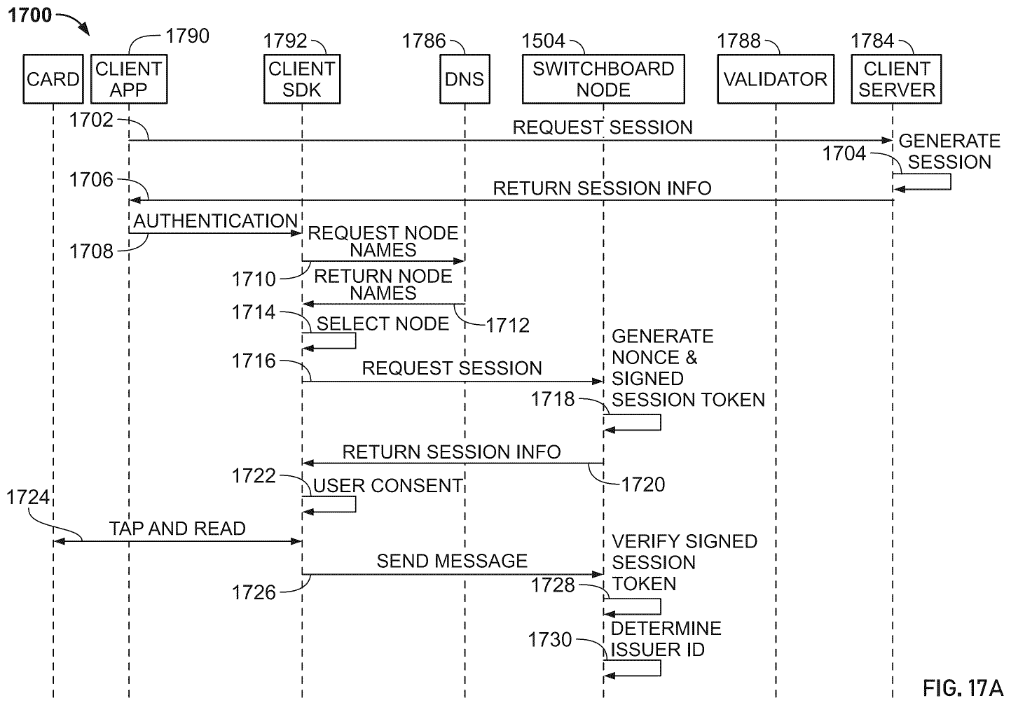

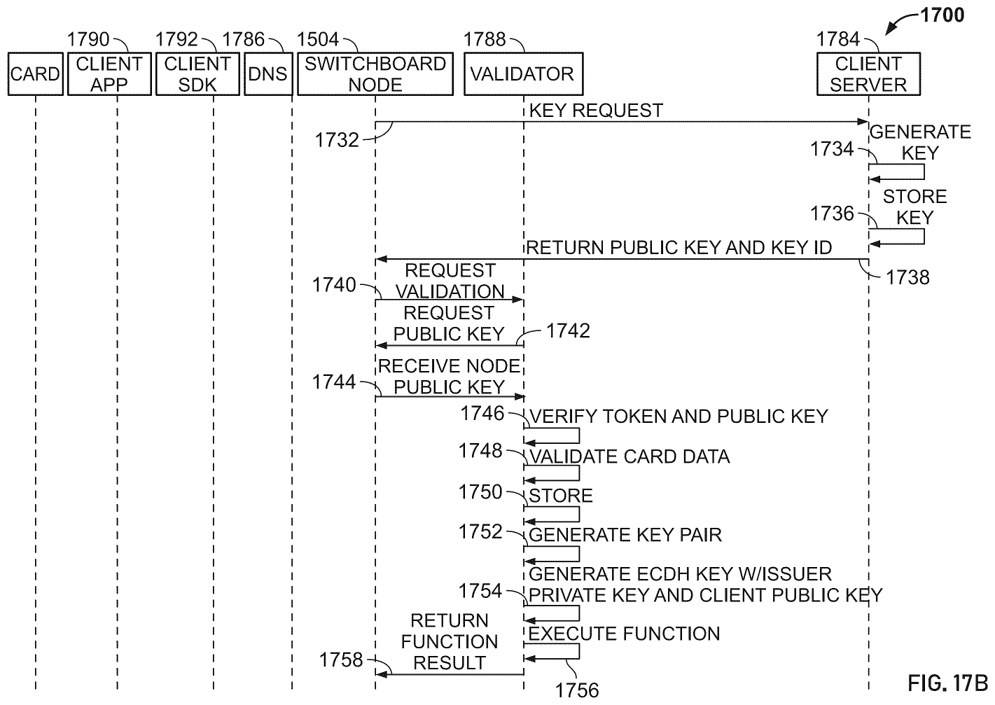

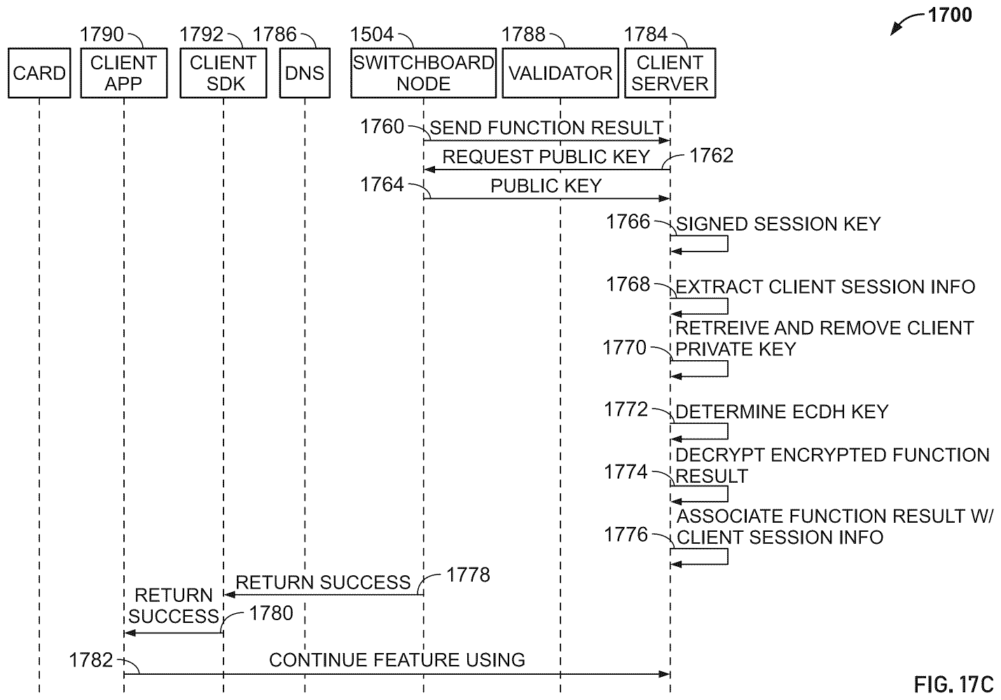

FIG. 17A-FIG. 17C illustrate an example sequence 1700 to perform operations between a contactless card and services provided by a card issuer and/or merchant. The illustrated sequence 1700 includes actions and communications performed by a contactless card 102, a client 1536 including a client app 1790 and a client sdk 1792, a DNS 1786, a switchboard system including one or more switchboard nodes 1504, a partner services 1532 including a merchant and/or validator 1788, and control services 1534 including a client server 1784 or system. In embodiments, the client app 1790 may be any application configured to execute on a client 1536, such as a banking app, a merchant app, a social media app, a travel app, a gaming app, a productivity app, an entertainment app, and so forth. In embodiments, the client app 1790 includes a web browser to provide websites and pages. The client app 1790 may include and/or utilize the client sdk 1792, which may be a set of instructions that enable the client app 1790 to communicate with other components of the switchboard system.

In embodiments, at 1702 the client 1536 including the client app may send a request and establish a session with a client server 1784 such that a result may be associated with the correct client device or user. The request establishes a relationship between the client device and client server, which may be an issuer server. At 1704, the client server 1784 generates a session and CLIENT SESSION INFORMATION. At 1706, the client server 1784 returns the session information, e.g., the CLIENT SESSION INFORMATION. In embodiments, the CLIENT SESSION INFORMATION may be the Client implementation-specific user session identification information.

At 1708, the client 1536 may initiate a contactless card authentication process with the client 1536. For example, the client 1536 may call a function and/or pass information to the client 1536 to initiate authentication via a contactless card. At 1710-1714, the client 1536 may utilize DNS to identify a node and establish communication with the node. Specifically, at 1710, the client 1536 including the client sdk 1792 may send a request for switchboard hostnames, and at 1712 the DNS 1786 may return information including one or more hostnames. At 1714, the client 1536 may determine a switchboard node to communicate. FIG. 16 illustrates an example of a more detailed sequence of the process to establish communication with a switchboard node.

At 1716, the client 1536 may send a request for a session to the switchboard system 108. In embodiments, the request for a session may be for a function request in the format <FUNCTION REQUEST>. In embodiments, the FUNCTION REQUEST may be the data/function that the client would like to request once a contactless card has been validated. The function could be for any service discussed herein, e.g., authenticate the user, perform a transaction, request autofill data, etc. At 418, switchboard system 108 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 108 private key. The switchboard system 108 may include a NODE PUBLIC/PRIVATE KEY, which is a keypair used to sign and validate JWTs.

At 1720, the switchboard system 108 may return session information to the client 1536. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 422, the client sdk 236 may determine and/or receive user consent to the terms of service. In one example, the client sdk 236 captures and records the user consent to <FUNCTION TOS> on <CONSENT DATE> with <TOS VERSION>. The CONSENT DATE may be the timestamp for the user's consent to the TOS.

At 1724, the client 1536 exchanges one or more messages with a contactless card. In one example, the exchange may be based on the contactless card being tapped to a client device. In embodiments, the client sdk 236 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an NDEF message format example.

| Byte | Data Item | Value |
|---|---|---|
| 00 | NDEF Message Tag | D1 (only record) |
| 01 | Length of Record Type | 01 |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX |
| | | encoded 4 bytes binary data |
| 0F . . . 12 | Session Indicators | 4 bytes of ASCII HEX |
| | | encoded 2 bytes binary data |
| 13 . . . 16 | Control Indicators | 4 bytes of ASCII HEX |
| | | encoded 2 bytes binary data |
| 17 . . . 26 | Update Date | 16 bytes of ASCII HEX |
| | creation Time | encoded 8 bytes binary data- |
| | | represents 64 bit unix |
| | | timestamp |
| 27 . . . 26 | Update MAC | MAC to protect control |
| | | indicators-16 bytes of |
| | | ASCII HEX encoded 8 bytes |
| | | binary data |

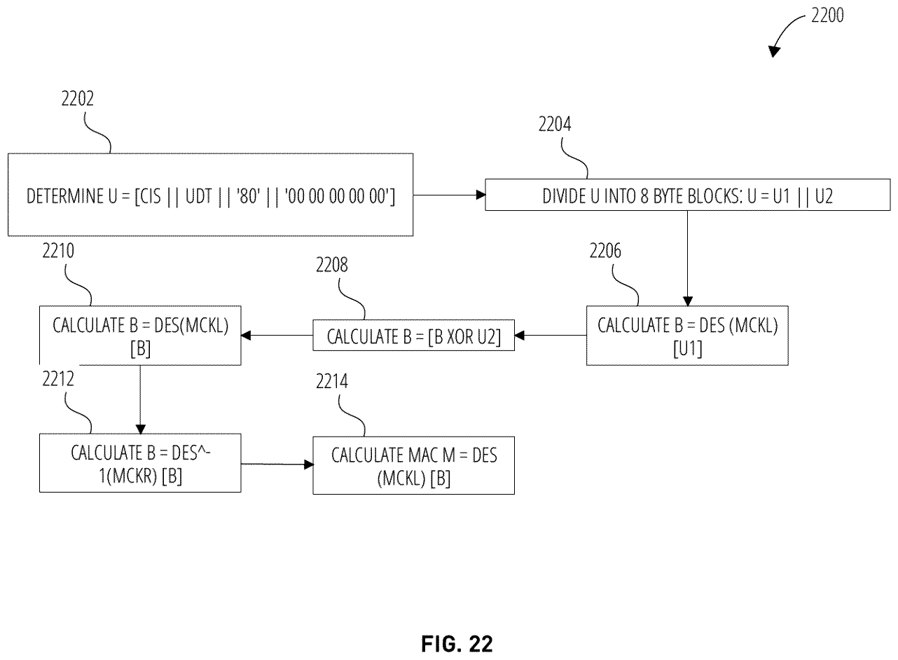

In embodiments, the updated MAC may be calculated to protect the control indicators. Specifically, The MAC M is determined by calculating a MAC over the 10 bytes of the update data U with the Update MAC Card Key (MCK), as described in FIG. 22, flow 2200.

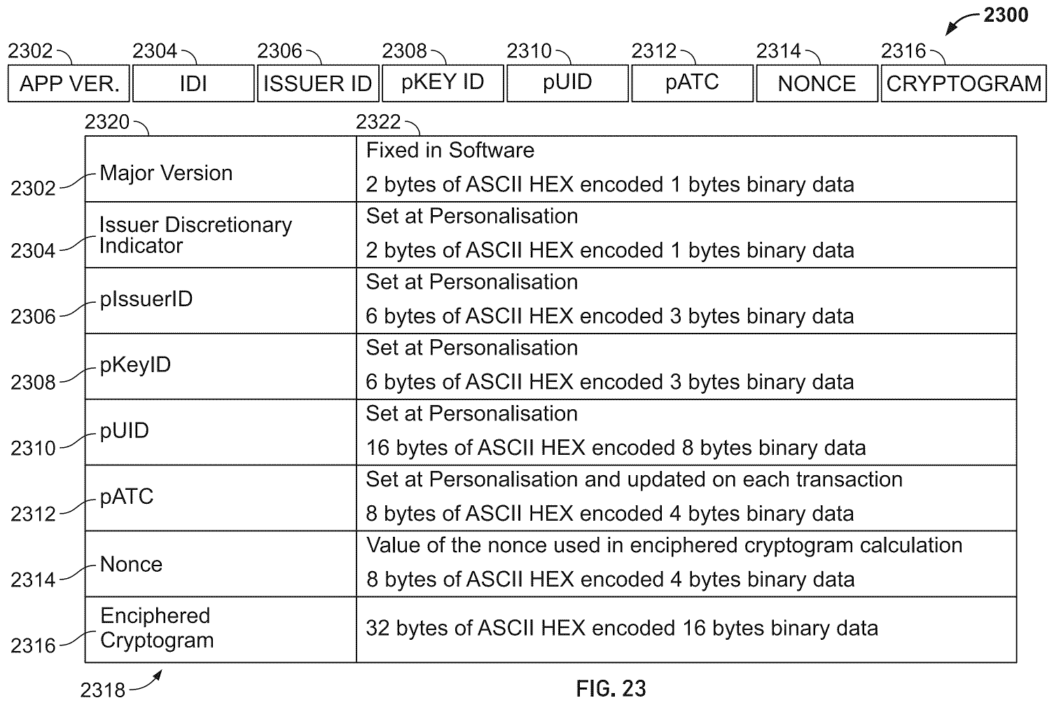

At 1724, the contactless card may generate and provide a message to the client device including the client sdk 1536. The data in the message may be utilized by the system discussed herein to perform the function requested. One example of the message is illustrated and discussed in FIG. 23, message 2300.

At 1726, the client including the client sdk 1536 may send a message and information to the switchboard system 108. The message may be the message received from the contactless card 102, e.g., message 2300. In addition, the client sdk 1536 may send the consent date, the TOS version, and the signed session token to the switchboard system 108. The switchboard system 108 may utilize the information to ensure that the session is valid. At 1728, the switchboard system 108 verifies the signed session token is valid, e.g., is the previously provided signed session token and includes the nonce previously generated and is in the message.

In some embodiments, the switchboard system is configured to determine which issuer system or client server it should route the message to for processing. At 1730, the switchboard system 108 may determine the issuer ID by extracting it from the message received from the contactless card 102 via the client sdk 1536. As mentioned, the issuer ID identifies the issuer of the contactless card 102.

In embodiments, the switchboard system is configured to generate and communicate secure communications with the issuer system, e.g., the client server 1784 and the validator 1788. At 1732, the switchboard system 108 sends a request for a key to the client server 1784. The key may be utilized to perform the secure communications. In one example, the key request may be an elliptical curve Diffie-Hellman (ECDH) key request. Embodiments are not limited in this manner and alternative key protocols may be utilized, e.g., Supersingular isogeny Diffie-Hellman key exchange (SIDH or SIKE), a private/public key pairing (RSA), etc.

At 1734, the client server 1784 generates a portion of the key. In some instances, the client server 1784 may generate half of the ECDH key for encryption/decryption of PII. Specifically, the client server 1784 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1736, the client server 1784 stores the generated portion of the key in a storage. Specifically, the client server 1784 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1784 may return the public key portion to the switchboard system 108 with the KEY ID at 1738. The switchboard system 108 may store the public key portion with the KEY ID for later use, e.g., generation of the ECDH key. At 1740, the switchboard system 108 may request a validation to be performed by the validator 1788. In one example, the switchboard system 108 may send a request validation as Request validation <MESSAGE>, <SIGNED SESSION TOKEN>, <CLIENT EC PUBLIC KEY>, <CONSENT DATE>, and the <TOS VERSION>. The validator 488 may make an out-of-band request back to the switchboard system 108 for the public key to verify the session at 442. At 444, the switchboard system 108 may provide the node's public key, i.e., <NODE PUBLIC KEY>. Further and at 446, the 488 may utilize the node's public key to verify the secure session token.

In embodiments, the validator 1788 may validate the message at 1748. In embodiments, the validator 1788 may perform a number of validations including ensure the nonce in the message is correct along with additional information, such as the card's unique identifier (pUID), and the counter value (pATC). In embodiments, the validator 1788 may perform other methods of validation as discussed herein.

At 1750, the validator 1788 may store information associated with the session. For example, validator 1788 may store the <CONSENT DATE> with the <TOS VERSION> and the <PUID>. The validator 1788 may also generate another portion of the key, e.g., the ECDH key. For example, the 1788 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1754, the validator 1788 may generate the complete ECDH key. For example, the validator 1788 generate the <ECDH KEY> from <ISSUER EC PRIVATE KEY> and <CLIENT EC PUBLIC KEY>. The ECDH KEY is the final key generated using ECDH key negotiation.

The validator 1788 may utilize the ECDH KEY to encrypt data for the function. For example, and in some instances, if the validator 1788 validates the message, the validator 1788 may execute a function request to create a function result and encrypts the result with the ECDH KEY at 456. For example, the validator 488 may Execute <FUNCTION REQUEST> to create <FUNCTION RESULT> and encrypt it with the <ECDH KEY>. The function result may be any result based on the requested function, e.g., verification of the card.

At 1758, the validator 1788 may return the function result to the switchboard system 108. In some instances, the function result is returned encrypted. For example, the validator 1788 may return the <ENCRYPTED FUNCTION RESULT> and the <ISSUER EC PUBLIC KEY>.

In embodiments, the switchboard system 108 sends the function result to the client server 1784 to process the result. In one example, the switchboard system 108 may send the <ENCRYPTED FUNCTION RESULT>, <KEY ID>, <ISSUER EC PUBLIC KEY>, and <SIGNED SESSION TOKEN>. At 1762 and 1764, the client server 1784 may make a request for and receive the public key from the switchboard system 108. In some instances, the exchanged may be performed via out-of-band communication channels. The public key for the node may be <NODE PUBLIC KEY>. The public key may be used to verify the sender of the function result, etc. At 1766, the 1784 may verify the signed session key with the node's public key <NODE PUBLIC KEY> to verify the sender of the information. At 1768, the client server 1784 may extract client information from the signed session token. For example, the client server 1784 may Extract <CLIENT SESSION INFO> from <SIGNED SESSION TOKEN>, i.e., extracting the client implementation-specific user session identification information.

Further and at 1770, the client server 1784 may retrieve the client private key with the KEY ID. Specifically, the client server 1784 may get and remove the <CLIENT PRIVATE KEY> from cache using the <KEY ID>. At 1772, the client server 1784 may generate or compute the ECDH key. For example, the client server 1784 may compute the <ECDH KEY> with the <CLIENT PRIVATE KEY>+<ISSUER EC PUBLIC KEY>. The client server 1784 may decrypt the function result with the computed key at 1774. Specifically, the client server 1784 may decrypt the <ENCRYPTED FUNCTION RESULT> with the <ECDH KEY> to determine the <FUNCTION RESULT>. At 1776, the client server 1784 associates the function result with the session.

In embodiments, the switchboard system 108 may return that the function result was successfully completed or not at 1778 to the client sdk 1792. Further and at 1780, the client sdk 1792 may notify the client app 1790 of the result. At 1782, the client app 1790 may utilize the feature. For example, the 1782 may communicate with the client server 1784 to continue the feature using the <CLIENT SESSION INFO> to fetch the redacted <FUNCTION RESULT>.

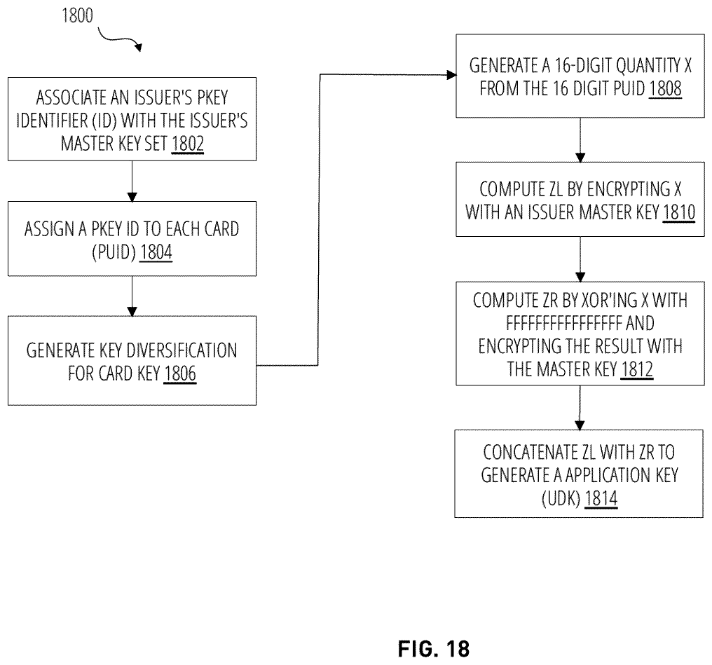

FIG. 18 illustrates flow 1800, an example of operations to identify the issuer's master keys and generate unique card master keys or application keys. In some instances, these operations may be performed off the card, at personalization time, and then stored in a memory of the card. Further, the issuer's master key(s) may be utilized to generate card master keys. The card master keys may be known as application keys or UDKs. Each contactless card may have one or more UDKs.

In embodiments, Each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, these one or more of the operations may be performed on card, e.g., at the time of manufacturer, each time an operation is performed with a key, and so forth.

At block 1802, embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the operations discussed in blocks block 1804 to block 1814.

At block 1804, the system assigns a pKey ID to a card or pUID, a card application's unique 16-decimal digital identify. At block 1806, the system initiates generating a card's UDK(s). At block 1808, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

At block 1810, the system computes or calculates (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

At block 1812, the system calculates or computes ZR is by XOR'ing X with FFFFFFFFFFFFFFFF and encrypting the result with an issuer master key. Again, an encryption algorithm such as DES, AES, RSA, etc, may be used to encrypt the result of the XOR'ing. At block 1814, the system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys.

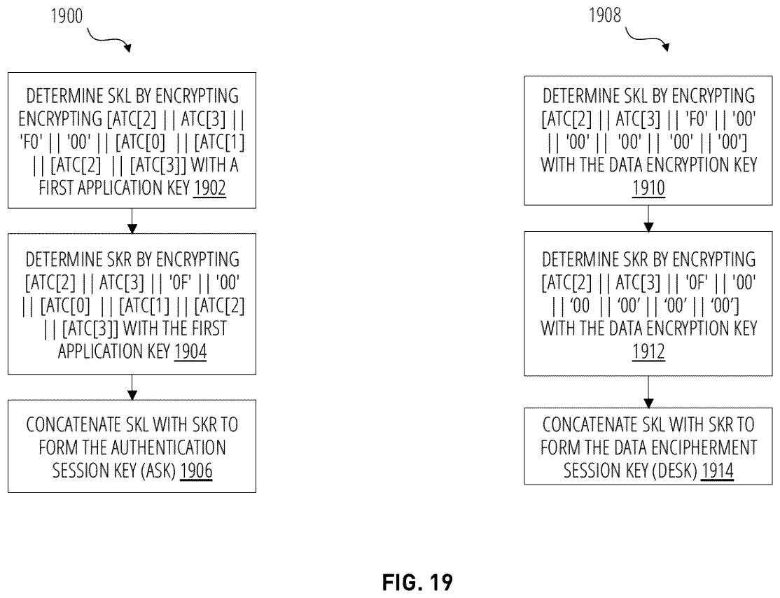

FIG. 19 illustrates a first flow 1900 to generate a unique cryptogram session key (ASK) and a second flow 1908 to generate a unique encipherment session key (DESK) in accordance embodiments. The operations discussed in flow 1900 and flow 1908 may be performed on the contactless card.

At block 1902, the contactless card including circuitry compute SKL by encrypting [ATC[2]∥ATC[3]∥‘F0’∥‘00’∥[ATC[0]∥[ATC[1]∥[ATC[2]∥[ATC[3]] with an application key, e.g., the key generated in flow 1800. Further, at block 1904 the contactless card compute SKR by encrypting [ATC[2]∥ATC[3]∥‘0F’∥‘00’∥[ATC[0]∥[ATC[1]∥[ATC[2]∥[ATC[3]] with the application key. Finally and at block 1906, the contactless card concatenates SKL with SKR to form an authentication session key (ASK). In embodiments, the ASK is used to perform operations utilizing the contactless card, such as encrypting the cryptographic MAC.

In embodiments, a card applet also supports session key derivation to generate a unique encipherment session key DESK as shown in flow 1908. At block 1910, the contactless card including circuitry Compute SKL by encrypting [ATC[2]∥ATC[3]∥‘F0’∥‘00’∥‘00’∥‘00’∥‘00’∥‘00’] with the Data Encryption Key (DEK) Further and at block 1912, the contactless card computes SKR by encrypting [ATC[2]∥ATC[3]∥‘0F’∥‘00’∥‘00’∥‘00’∥‘00’∥‘00’] with the Data Encryption Key At block 1914, the contactless card concatenate SKL with SKR to form the Data Encipherment Session Key.

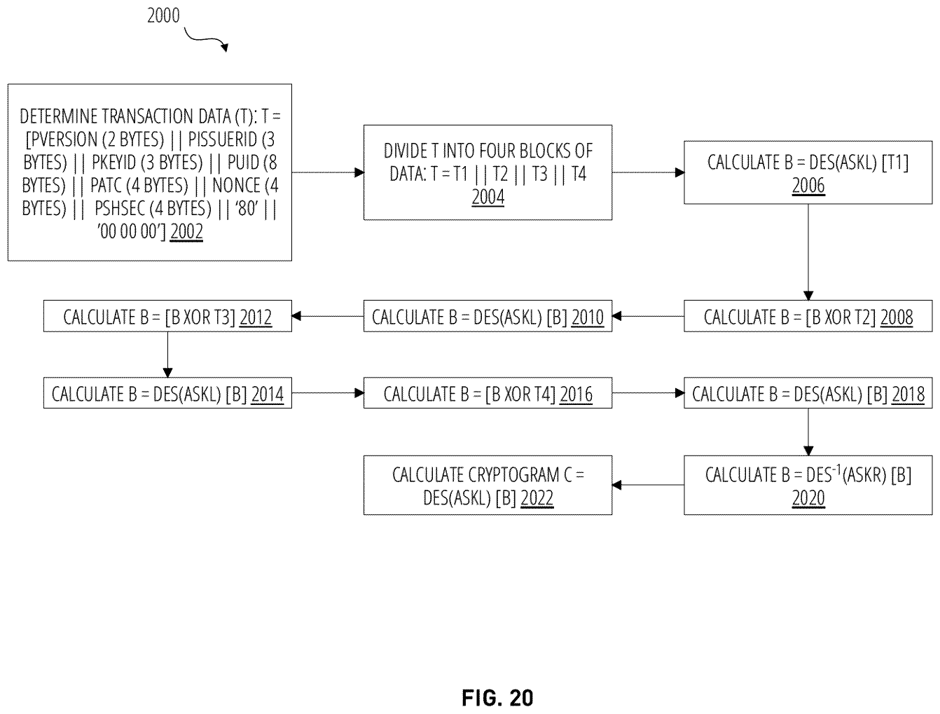

FIG. 20 illustrates an example flow 2000 that may be performed by a contactless card or circuitry thereon to generate a cryptogram to perform operations discussed herein, e.g., see FIG. 23, message 2300. The cryptogram C is determined by calculating a MAC over the 32-byte transaction data T using the Authentication Session Key (ASK). FIG. 19, flow 1900 illustrates and discusses generating an ASK in accordance with embodiments discussed herein.

At block 1802, the contactless card including circuitry computes T=[pVersion (2 bytes)∥pIssuerID (3 bytes)∥pKeyID (3 bytes)∥pUID (8 bytes)∥pATC (4 bytes)∥nonce (4 bytes)∥pSHSEC (4 bytes)∥‘80’∥‘00 00 00’]. In one example, the pVersion is an applet version number, the pIssuerID is an issuer identifier, the pKeyID includes data that identifies a set of master keys for a card issuer of the contactless card, the pUID is a card unique identifier assigned to the contactless card, the pATC is a card's counter value, the nonce is the nonce provided during communication with another device as discussed herein, and the pSHSEC is value to indicate adherence to Secure Hardware Security Evaluation Criteria.

The contactless card may process the data to generate the cryptogram. At block 1804, the contactless card divides T into four blocks of 8 bytes of data: T=T1∥T2∥T3∥T4. At block 1806, the contactless card computes B=DES(ASKL) [T1], where is the Data Encryption Standard or another symmetric encryption algorithm, ASKL is a portion of the ASK, e.g., the “left” half of the key. At block 1808, the contactless card computes B=[B XOR T2], and at block 1810, the contactless card computes B=DES(ASKL) [B], where DES is an encryption algorithm. At block 1812, the contactless card computes B=[B XOR T3], and at block 1814, the contactless card computes B=DES(ASKL) [B]. At block 1816, the contactless card computes B=[B XOR T4] and at block 1818 the contactless card computes B=DES(ASKL) [B]. At block 1820, the contactless card compute B=DES⁻¹(ASKR) [B], where DES⁻¹ is the reciprocal DES operation and ASKR is a portion of the ASK, e.g., the right half. At block 422, the contactless card computes the cryptogram C=DES(ASKL) [B].

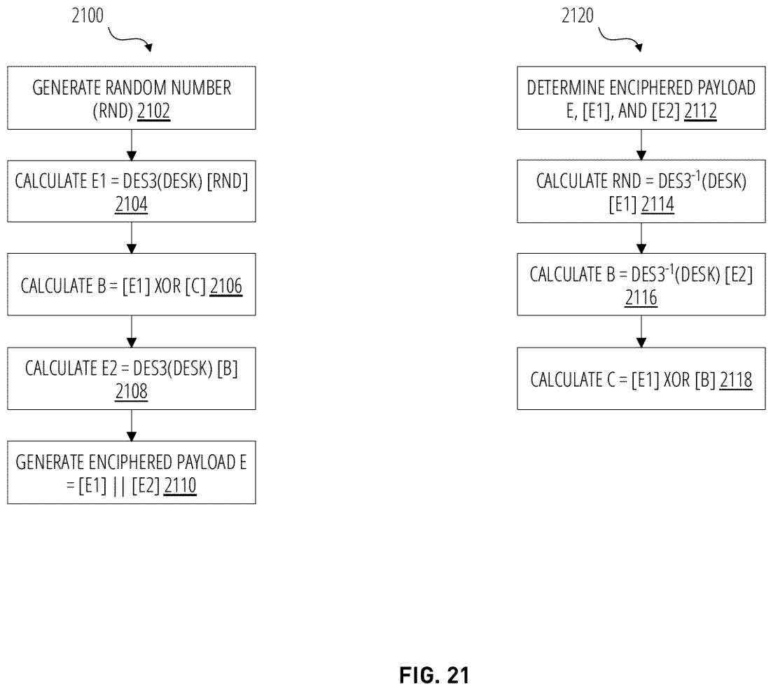

In embodiments, a contactless card may encipher the cryptogram to secure the data further. FIG. 21 illustrates an example flow 2100 to encipher the cryptogram with the Data Encipherment Session Key (DESK) (FIG. 19, flow 1908) being used to encrypt in Cipher Block Chaining mode (CBC).

At block 2102, a contactless card including circuitry is configured to generate an 8-byte random number [RND]. At block 2104, the contactless card computes E1=DES3(DESK) [RND], where DES3 is a symmetric encryption algorithm such as the Triple Data Encryption Standard. At block 2106, the contactless card computes B=[E1] XOR [C], where C is the cryptogram generated in flow 2000. The contactless card computes E2=DES3(DESK) [B] at block 2108, where B is computed above in FIG. 20, flow 2000. At block 2110 the contactless card generates the 16 byte enciphered payload E=[E1] ∥[E2].

In embodiments, a device or the contactless card my decrypt the payload E in accordance with flow 2120. At block 2112, a device determines or retrieves the payload E. At block 2114, the device computes a RND=DES3-1(DESK) [E1]. At block 2116, the device determines B=DES3-1(DESK) [E2], and at block 2118, the device computes C=[E1] XOR [B].

FIG. 22 illustrates an example flow 2200 for calculate a message authentication code (MAC). The operations of flow 2200 by circuitry of the contactless card. In some instances, the MAC may be an updated MAC. In embodiments, the updated MAC is included in data communicated from a contactless card to another device, such as a mobile device, point-of-sale (POS) terminal, or any other type of computer. In one example, the update MAC may be included in an NDEF message.

In embodiments, the updated MAC may be calculated to protect the control indicators and include updated date/time. For example, the update MAC M is determined by calculating a MAC over the 10 bytes of the update data U with the Update MAC Card Key (MCK) as follows.

At block 2202, embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, at block 2204, data U is broken into two blocks of 8 bytes of data, where U=U₁∥U₂. Further, operations may be performed on U₁ and U₂.

At block 2206 embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

At block 2208 an additional operation may be performed on the result B. Specifically, the result B may be exclusively or'd (XOR) with a second portion of the data (U₂).

The updated result B may be further processed at block 2210. For example, result B may be further processed by applying the DES algorithm using MCKL again to B. The result B of block 2210 may further be processed at block 2212. Specifically, the result B may be processed by the inverse DES with a second portion (R) of the MCK (MCKR). And at block 2214, the MAC M may be determined by applying the DES algorithm with the MCKL to result B of block 2212.

FIG. 23 illustrates an example of a message 2300 that may be communicated by a contactless card to perform the functions discussed herein. One or more of the fields in message 2300 may also be utilized to route the message 2300 through the switchboard system and perform authentication/validation techniques.

In embodiments, the message 2300 includes an applet version 2302 field, an issuer discretionary indicator 2304 field, an Issuer Identifier 2306 field, a pKey ID 2308 field, a p UID 2310 field, a pATC 2312 field, a nonce 2314 field, and an encrypted cryptogram 2316.

In embodiments, the fields may be in plain text or encrypted. For example, the applet version 2302 field may include an applet version in plain text. The applet version to indicate which applet version is installed on a contactless card and may be used by the other systems to determine how to process the message 2300 when communicated. For example, different Applet versions require different validation logic, e.g., an older message may be routed through the issuer system to perform various operations for validation, while a newer message may be routed through the switchboard system to perform the various operations, including validation.

In embodiments, the message 2300 includes an issuer discretionary indicator 2304 field that may include issuer data and set at the time of personalization. In addition, the message 2300 includes an Issuer Identifier 2306 field that may include a unique ID assigned to the entity issuing the card, e.g., the issuer. For example, each issuer may be assigned a unique identifier during an onboarding operation when joining the system. The issuer ID can be used by the switchboard system 1508 to route a message and its contents to the appropriate services that are associated with that particular issuer.

In embodiments, the message 2300 includes a pKey ID 2308 field. In some instances, the pKey ID 2308 field may include data that identifies a set of master keys for a card issuer. The issuer's set of master keys may utilize each cards set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's masters keys to regenerate session keys by the system to perform a validation.

In embodiments, each contactless card 1502 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described in FIG. 18, flow 1800.

The message 2300 may include a pUID 2310 field, including a card unique identifier assigned to the contactless card at personalization time. The pUID 2310 field data may be a combination of alphanumeric characters used to uniquely identify each card and associated with a user.

In embodiments, the message 2300 includes a pATC 2312 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 2300 is created, a new session key is derived and utilized to generate one or more portions of the message 2300. Specifically, a session key is used to calculate the cryptographic MAC (Application Cryptogram). The card's applet supports a session key derivation option to generate a unique cryptogram session key ASK as discussed in FIG. 19, flow 1900 and unique encipherment session key (DESK) as discussed in flow 1908. The generation of the cryptogram is discussed in flow 600 and flow 2100. Further the cryptogram may decrypted in accordance with flow block 2108.

In embodiments, a portion of the data provided in message 2300 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 1502 may communicate a message between a device, such as a mobile device, during a read operation. For example, in response to the contactless card 1502 being tapped onto a surface of the device, e.g., brought within wireless communication range, a read operation may be performed on the contactless card 1502, and the contactless card 1502 may generate and provide the message to the device. For example, once within range, the contactless card 1502 and the device may perform one or more exchanges for the contactless card 1502 to send the message to the device. FIG. 4A, step 424 illustrates one example of an exchange.

The wireless communication may be in accordance with a wireless protocol, such as near-field communication (NFC), Bluetooth, WiFi, and the like. In some instances, a message may be communicated between a contactless card 1502 and a device via wired means, e.g., via the contact pad 304, and in accordance with the EMV protocol.

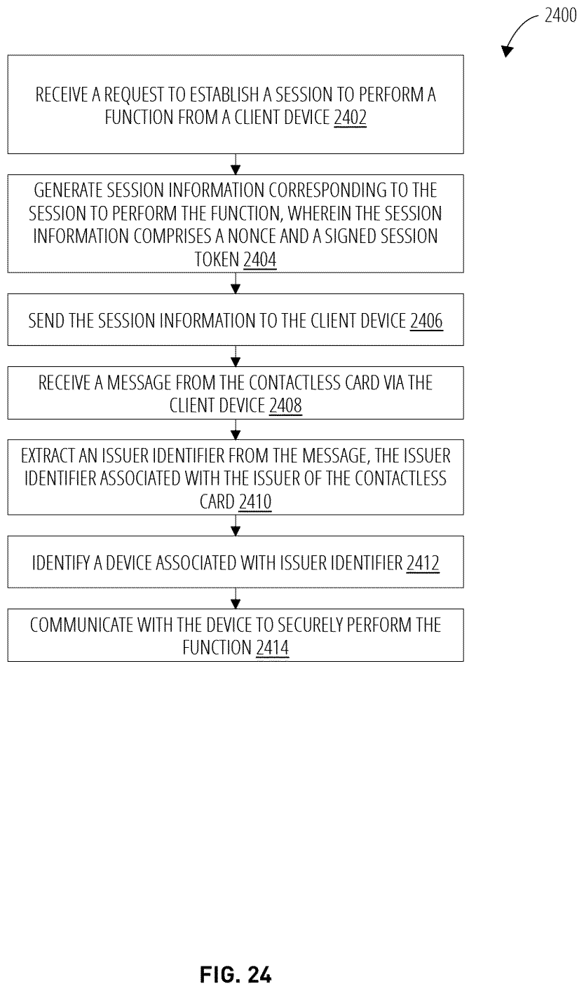

FIG. 24 illustrates an example of routine 2400 in accordance with embodiments discussed herein. In block 2402, the routine 2400 includes receiving, by a node in a system, a request to establish a session to perform a function from a client device, wherein the function is at least partially performed utilizing a contactless card. In some instances, the node may be one of a plurality nodes of a switchboard system. The node may be previously selected by the sending device via a DNS operation performed.

In block 2404, the routine 2400 includes generating, by the node, session information corresponding to the session to perform the function, wherein the session information comprises a nonce and a signed session token. The nonce and/or signed session token may be utilized by systems to perform the functions discussed herein while ensuring the node routing the data is authenticate, the message from the contactless card is authenticate, and to keep track of the session for the function.

In block 2406, routine 2400 includes sending, by the node, the session information to the client device. The client device may communicate with a contactless card to receive data from the card to authenticate and perform a function. In some instances, the client device may send the nonce from the node to the contactless card. The contactless card may utilize the nonce when generating the message to communicate back to the client device and finally, the node, e.g., incorporates it into a cryptographic portion of the message (see FIG. 23).

In block 2408, routine 2400 includes receiving, by the node, a message from the contactless card via the client device. The message may be generated by the contactless card. FIG. 23 illustrates one example of a message 2300. In some embodiments, the node verifies the message. For example, the node may verify a nonce in the message and a signed session token.

In block 2410, routine 2400 extracts, by the node, an issuer identifier from the message, the issuer identifier associated with the issuer of the contactless card. In some instances, the issuer identifier may be in a plaintext format.

In block 2412, routine 2400 identifies, by the node, a device associated with the issuer identifier. For example, the node may perform a lookup to determine a server associated with the issuer identifier and the function to be performed.

In block 2414, routine 2400 communicates, by the node, with the device to securely perform the function.

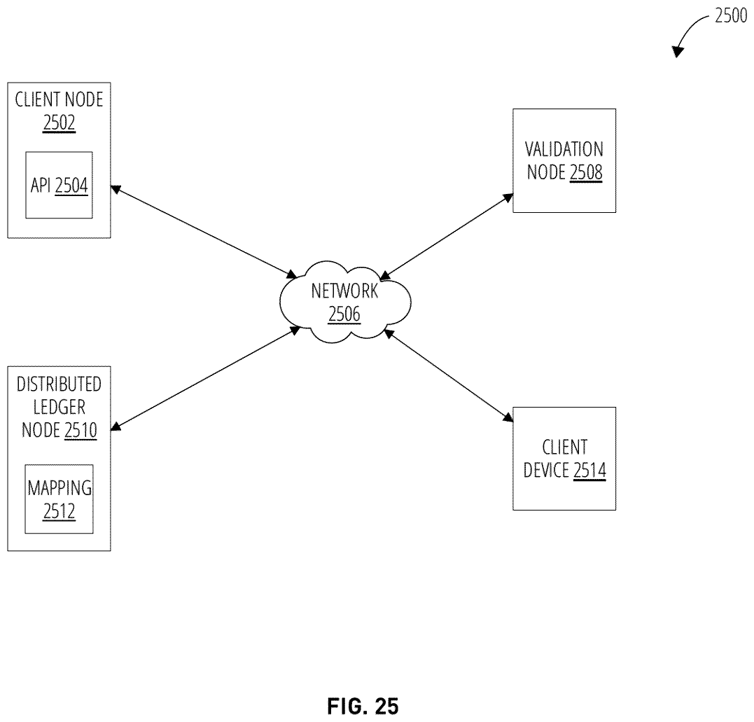

FIG. 25 illustrates a distributed network authentication system 1100 according to an example embodiment. As further discussed below, system 1100 can include client node 2502, API 2504, network 2506, distributed ledger node 2510, mapping 2512, and client device 2514. Although FIG. 25 illustrates single instances of the components, system 1100 can include any number of components.

System 1100 can include a client node 2502, which can be a network-enabled computer as discussed herein. In some examples, client node 2502 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, client node 2502 can execute one or more applications, such as software applications, that enable, for example, network communications with one or more components of system 1100, transmit and/or receive data, and perform the functions and processes discussed herein.

The client node can contain an API 2504. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 2504 to interact with the service, such as by performing a remote call to an API for interacting with a web-based service.

API 2504 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 2502 can communicate with one or more other components of system 1100 either directly or via network 2506. Network 2506 can comprise one or more of a wireless network, a wired network or any combination of wireless network and wired network, and may be configured to connect the components of system 1100. While FIG. 25 illustrates communication between the components of system 1100 through network 2506, it is understood that any component of system 1100 can communicate directly with another component of system 1100, e.g., without involving network 2506.

System 1100 can include a validation node 2508, which can be a network-enabled computer as discussed herein. In some examples, validation node 2508 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, validation node 2508 can execute one or more applications, such as software applications, that enable, for example, network communications with one or more components of system 1100, transmit and/or receive data, and perform the functions and processes discussed herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1100 can include a distributed ledger node 2510, which can be a network-enabled computer as discussed herein. In some examples, distributed ledger node 2510 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, distributed ledger node 2510 can execute one or more applications, such as software applications, that enable, for example, network communications with one or more components of system 1100, transmit and/or receive data, and perform the functions and processes discussed herein.

Distributed ledger node 2510 can containing a mapping 2512. In some examples, mapping 2512 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1100, or the one or more databases can be hosted externally to any component of the system 1100. In some examples, the one or more databases can be contained in the distributed ledger node 2510, and in other examples the one or more databases can be stored outside of distributed edger node 2510 but in data communication with distributed ledger node 2510. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 2510. In other examples, the one or more databases can be remote from distributed ledger node 2510 but in data communication with distributed ledger node 2510. Data communication between the one or more databases and distributed ledger node 2510 can be a direct data communication or data communication via a network, such as the network 2506.

In some examples, client node 2502 can be in data communication with distributed ledger node 2510. Distributed ledger node 2510 can contain mapping 2512. Mapping 2514 may include, e.g., a mapping between a validation node address and the validation node 2508, a mapping between a routing number and a validation node address, and/or a mapping between a routing number and validation node 2508. In some examples, mapping 2512 can include a digital signature associated with an entity having permission to validate for a routing number. Based on one or more of these associations, client node 2502 can call validation node for validation and/or provide direction to the client device to reach the appropriate validation node. This can be accomplished by calling a validation API associated with validation node 2508.

In some examples, iterations of the mappings discussed herein, such as mapping 2512, can also include a software or applet version number. The version number can be used to identify a validation node or validation node address or choose between multiple validation addresses for one validation node.

In some examples, client node 2502 and distributed ledger node 2510 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 2510 can update mapping 2512 to reflect a different association between, e.g., a routing number, a validation node address, and a validation node. In some examples, degrees of permissions can be issued. For example, if client node 2502 were to function to route data to validation node 2508 (or other validation nodes), client node 2502 can be given a certain level of permissions. As another example, if distributed ledger node 2510 were to have the capability to update mapping 2512, distributed ledger node 2510 can have a different, higher level of permissions.

System 1100 can include a client device 2514, which can be a network-enabled computer as discussed herein. In some examples, distributed ledger node 2514 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 2514 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 2514 can be in data communication with another network-enabled computer not shown in FIG. 25, such as a smart card (e.g., a contactless card or a contact-based card).

In some examples, client device 2514 can execute one or more applications, such as software applications, that enable, for example, network communications with one or more components of system 1100, transmit and/or receive data, and perform the functions and processes discussed herein.

In some examples, upon receipt of an authentication request, client device 2514 can call (e.g., via an API) client node 2502. The call can include a routing number and/or an applet or software version number, and client node 2502 can query distributed ledger node 2510 and mapping 2512. Once the query returns the identification of a validation node (e.g., validation node 2508) and/or a validation node address associated with that routing number and/or applet or software version, client node 2502 can reply to client device 2514. Client device 2514 can then proceed with authentication with the validation node. The authentication can be performed by, e.g., the systems and methods discussed herein, such as by the generation, encryption, transmission, decryption, and validation of a cryptogram as discussed herein.

In some examples, client node 2502 can be co-resident with validation node 2508. In these examples, client node 2502 can handle the authentication in a single call from client device 2514. In some examples, this can be acceptable only if it is permissible for the full authentication transmission (e.g., a cryptogram as discussed herein) to be sent to client nodes that are not involved in authentication.

In some examples, if client node 2502 receives, from client device 2514, a routing number that is not handled by its location, client node 2502 can return a code indicating that this routing number is not handled, along with validation node address for the responsible validation node. Client device 2514 can then send the full authentication transmission to validation node 2508 using the received validation node address.

In some examples, client node 2502 can enter the distributed network with different permissions. For example, client node 2502 can be a read-only router of data. As another example, client node 2502 can have permission to send messages to distributed ledger node 2510 updating one or more routing paths for one or more routing numbers. However, client node 2502 would be prevented from updating one or more routing paths for one or more routing numbers for other entities that control other routing numbers which are not associated with client node 2502 or that did not grant this permission. As another example, distributed ledger node 2510 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 2502, distributed ledger node 2510, and/or validation node 2508, if security, legal, and/or financial conditions are met, however, delegation is not required.

In some examples, one or more APIs can facilitate communication between components of system 1100 via network 2506. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 2508 for authentication, can require storage of the keys in one or more HSMs, to promote key security and ensure that the keys are never entered into memory.

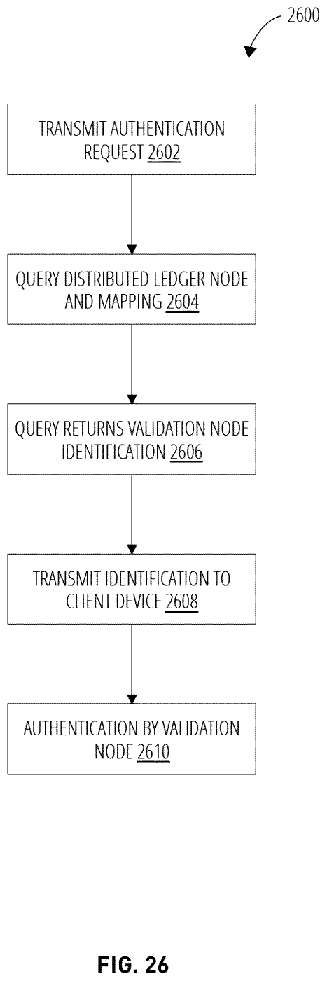

FIG. 26 illustrates a method 2600 performed by a distributed network authentication system according to an example embodiment. For example, the method can be performed by distributed network authentication system 2500 and or by another distributed network authentication system.

In block 2602, a client device can transmit an authentication request to a client node. The authentication request can include, without limitation, a routing number, a software version number, and/or an applet version number. The request can be made by an API call or other communication between the client device and the client node.

In block 2604, after receiving the authentication request, the client node can transmit a query (e.g., via an API call) to a distributed ledger node. The distributed ledger node contain a mapping, and the distributed ledger node can submit the query to the mapping.

In block 2606, the query can return an identification of a validation node and/or a validation node address, and the distributed ledger node can transmit this identification to the client node.

In block 2608, the client node can transmit the identification to the client device. After receiving the identification, the client device can proceed with authentication with the identified validation node and/or validation node address, in block 2610.

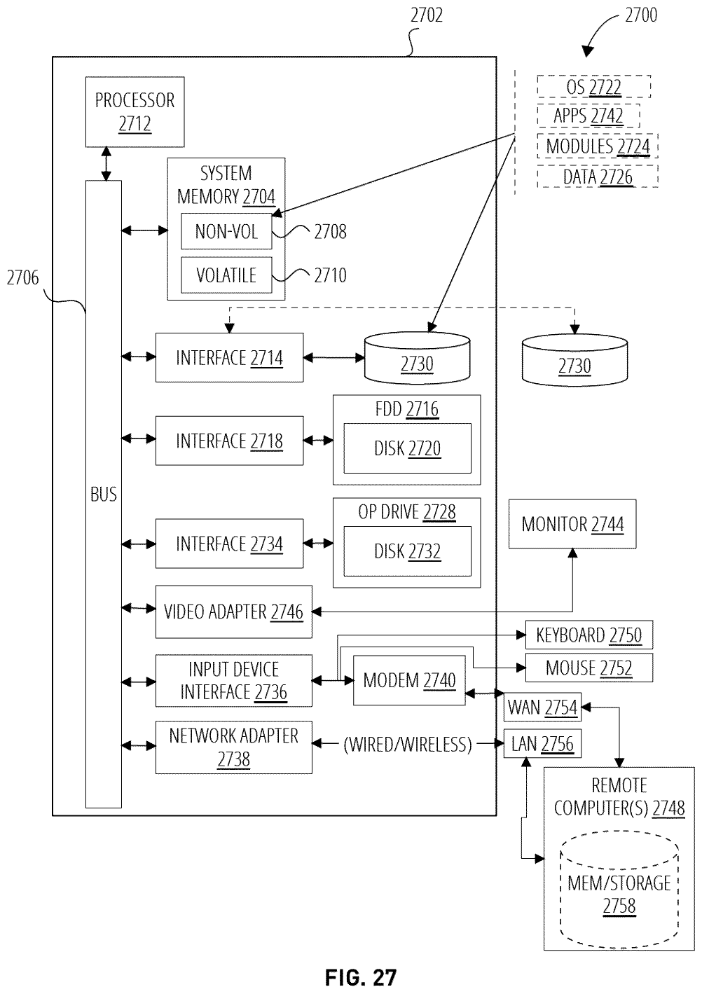

FIG. 27 illustrates an embodiment of an exemplary computer architecture 2700 suitable for implementing various embodiments as previously described. In one embodiment, the computer architecture 2700 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 2700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 27, the computing architecture 100 includes a processor 2712, a system memory 2704 and a system bus 2706. The processor 2712 can be any of various commercially available processors.

The system bus 2706 provides an interface for system components including, but not limited to, the system memory 2704 to the processor 2712. The system bus 2706 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations discussed herein.

The system memory 2704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 27, the system memory 2704 can include non-volatile 2708 and/or volatile 2710. A basic input/output system (BIOS) can be stored in the non-volatile 2708.

The computer 2702 may include various types of computer-readable storage media in the form of one or more lower speed memory units, including an internal (or external) hard disk drive 2730, a magnetic disk drive 2716 to read from or write to a removable magnetic disk 2720, and an optical disk drive 2728 to read from or write to a removable optical disk 2732 (e.g., a CD-ROM or DVD). The hard disk drive 2730, magnetic disk drive 2716 and optical disk drive 2728 can be connected to system bus 2706 the by an HDD interface 2714, and FDD interface 2718 and an optical disk drive interface 2734, respectively. The HDD interface 2714 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 2708, and volatile 2710, including an operating system 2722, one or more applications 2742, other program modules 2724, and program data 2726. In one embodiment, the one or more applications 2742, other program modules 2724, and program data 2726 can include, for example, the various applications and/or components of the systems discussed herein.

A user can enter commands and information into the computer 2702 through one or more wire/wireless input devices, for example, a keyboard 2750 and a pointing device, such as a mouse 2752. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 2712 through an input device interface 2736 that is coupled to the system bus 2706 but can be connected by other interfaces such as a parallel port, IEEE 1394 serial port, a game port, a USB port, an IR interface, and so forth.

A monitor 2744 or other type of display device is also connected to the system bus 2706 via an interface, such as a video adapter 2746. The monitor 2744 may be internal or external to the computer 2702. In addition to the monitor 2744, a computer typically includes other peripheral output devices, such as speakers, printers, and so forth.

The computer 2702 may operate in a networked environment using logical connections via wire and/or wireless communications to one or more remote computers, such as a remote computer(s) 2748. The remote computer(s) 2748 can be a workstation, a server computer, a router, a personal computer, portable computer, microprocessor-based entertainment appliance, a peer device or other common network node, and typically includes many or all the elements described relative to the computer 2702, although, for purposes of brevity, only a memory and/or storage device 2758 is illustrated. The logical connections depicted include wire/wireless connectivity to a local area network 2756 and/or larger networks, for example, a wide area network 2754. Such LAN and WAN networking environments are commonplace in offices and companies, and facilitate enterprise-wide computer networks, such as intranets, all of which may connect to a global communications network, for example, the Internet.

When used in a local area network 2756 networking environment, the computer 2702 is connected to the local area network 2756 through a wire and/or wireless communication network interface or network adapter 2738. The network adapter 2738 can facilitate wire and/or wireless communications to the local area network 2756, which may also include a wireless access point disposed thereon for communicating with the wireless functionality of the network adapter 2738.

When used in a wide area network 2754 networking environment, the computer 2702 can include a modem 2740, or is connected to a communications server on the wide area network 2754 or has other means for establishing communications over the wide area network 2754, such as by way of the Internet. The modem 2740, which can be internal or external and a wire and/or wireless device, connects to the system bus 2706 via the input device interface 2736. In a networked environment, program modules depicted relative to the computer 2702, or portions thereof, can be stored in the remote memory and/or storage device 2758. It will be appreciated that the network connections shown are exemplary and other means of establishing a communications link between the computers can be used.

The computer 2702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously discussed herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

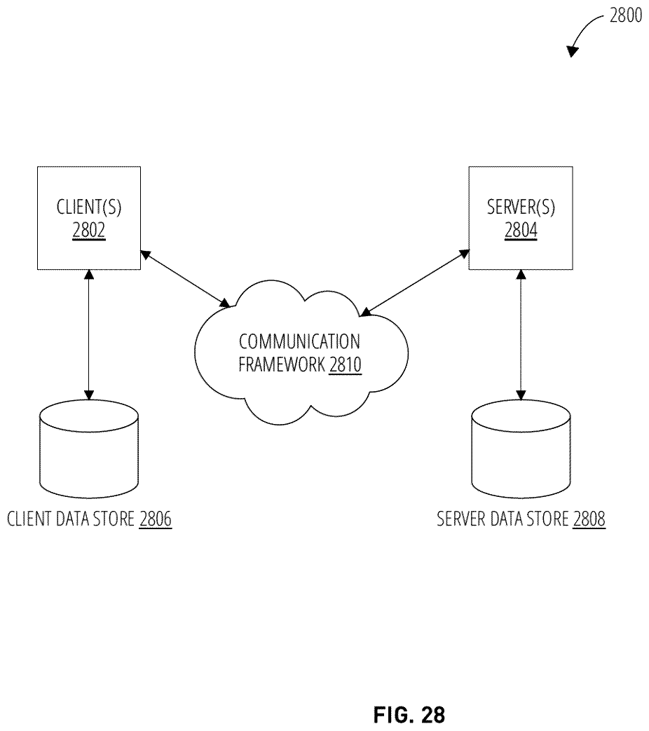

FIG. 28 is a block diagram depicting an exemplary communications architecture 2800 suitable for implementing various embodiments as previously described. The communications architecture 2800 includes various common communications elements, such as a transmitter, receiver, transceiver, radio, network interface, baseband processor, antenna, amplifiers, filters, power supplies, and so forth. The embodiments, however, are not limited to implementation by the communications architecture 2800, which may be consistent with systems and devices discussed herein.

As shown in FIG. 28, the communications architecture 2800 includes one or more client(s) 2802 and server(s) 2804. The server(s) 2804 may implement one or more functions and embodiments discussed herein. The client(s) 2802 and the server(s) 2804 are operatively connected to one or more respective client data store 2806 and server data store 2808 that can be employed to store information local to the respective client(s) 2802 and server(s) 2804, such as cookies and/or associated contextual information.

The client(s) 2802 and the server(s) 2804 may communicate information between each other using a communication framework 2810. The communication framework 2810 may implement any well-known communications techniques and protocols. The communication framework 2810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 2802 and the server(s) 2804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

What is claimed is:

1. A communication device, comprising:
a system on a chip (SoC),
wherein the communication device:
generates a communication field,
displays a prompt to tap a contactless card on the communication device,
reads the contactless card after entry into the communication field,
performs an authentication of the contactless card, and
after a successful authentication of the contactless card, performs a payment transaction.

2. The communication device of claim 1, wherein:
after the successful authentication and prior to the payment transaction, the communication device displays one or more user interfaces,
the one or more user interfaces comprises at least one selected from the group of a user interface seeking additional verification, a user interface displaying data, a user interface for a point of access device, and a user interface providing access to additional functionalities.

3. The communication device of claim 2, wherein:
after display of the one or more user interfaces, the communication device provides access to one or more functionalities, and
the one or more functionalities comprise at least one selected from the group of access to media content, a discount, a promotion, a loyalty benefit, and rewards points.

4. The communication device of claim 3, wherein the access to media content comprises at least one selected from the group of access to entertainment content and access to sports content.

5. The communication device of claim 1, wherein, in authenticating the contactless card, the communication device:
receives, from the read of the contactless card, an encrypted cryptogram,
generates an authentication session key,
generates an encryption session key,
decrypts the encrypted cryptogram using the encryption session key, and
validates the cryptogram using the authentication session key.

6. The communication device of claim 5, wherein:
the SoC stores an authentication diversified key, an encryption diversified key, and a counter value,
the authentication session key is generated using the authentication diversified key, the counter value, and a cryptographic algorithm, and
the encryption session key is generated using the encryption diversified key, the counter value, and the cryptographic algorithm.

7. The communication device of claim 1, wherein:
the communication device receives, from the read of the contactless card, an issuer identifier, and
the issuer identifier identifiers at least one selected from the group of an issuer of the contactless card and a device associated with the issuer of the contactless card.

8. The communication device of claim 1, wherein, after an unsuccessful authentication, the communication device performs the payment transaction.

9. A method performed by a communication device comprising a system on a chip (SoC), the method comprising:
generating a communication field;
displaying a prompt to tap a contactless card on the communication device;
reading the contactless card after entry into the communication field;
performing an authentication of the contactless card; and
after a successful authentication of the contactless card, performing a payment transaction.

10. The method of claim 9, further comprising:
after the successful authentication and prior to the payment transaction, displaying one or more user interfaces,
the one or more user interfaces comprises at least one selected from the group of a user interface seeking additional verification, a user interface displaying data, a user interface for a point of access device, and a user interface providing access to additional functionalities.

11. The method of claim 10, wherein:
the one or more user interfaces comprises one or more user interfaces seeking additional verification, and
the one or more user interfaces seeking additional verification comprise at least one selected from the group of a user interface requesting submission of login credentials, a user interface requesting age verification, a user interface requesting address information, and a user interface requesting biometric information.

12. The method of claim 11, wherein the biometric information comprises at least one selected from the group of a facial scan, a fingerprint scan, a retina scan, and a voice input.

13. The method of claim 10, further comprising:
after display of the one or more user interfaces, providing access to one or more functionalities,
wherein the one or more functionalities comprise at least one selected from the group of access to one or more accounts and the ability to conduct transactions using the one or more accounts.

14. The method of claim 13, wherein the one or more accounts comprise at least one selected from the group of a rewards account, a merchant account, a utilities account, a financial account, a brokerage account, a travel account, and a point of access account.

15. The method of claim 13, wherein the one or more accounts comprise at least one selected from the group of a credit card, a debit card, and a gift card.

16. A non-transitory computer-readable medium comprising instructions for execution by a communication device, wherein, upon execution of the instructions the communication device performs procedures comprising:
generating a communication field;
displaying a prompt to tap a contactless card on the communication device;
reading the contactless card after entry into the communication field;
performing an authentication of the contactless card; and
after a successful authentication of the contactless card, performing a payment transaction.

17. The non-transitory computer-readable medium of claim 16, the procedures further comprising:
after the successful authentication, displaying one or more user interfaces,
the one or more user interfaces comprises at least one selected from the group of a user interface seeking additional verification, a user interface displaying data, a user interface for a point of access device, and a user interface providing access to additional functionalities.

18. The non-transitory computer-readable medium of claim 17, wherein the additional functionalities comprise access to a building, a room, a locker, a storage unit, and a vehicle.

19. The non-transitory computer-readable medium of claim 17, wherein the additional functionalities comprise access to at least one selected from the group of a loyalty program status, a reward points balance, a frequent flyer mile balance, a redemption option, and a past redemption.

20. The non-transitory computer-readable medium of claim 17, wherein:
the one or more user interfaces comprise one or more user interfaces for a point of access device, and
the one or more user interfaces for the point of access device comprise at least one selected from the group of a user input interface, a biometric user interface, and a photographic input interface.
